(19) United States
(12) Patent Application Publication
(10) Pub. No.: US 2026/0128826 A1
(43) Pub. Date: May 7, 2026

(54) COMMUNICATIONS BETWEEN ACCESS POINTS WITH DIFFERENT CHANNEL CONFIGURATIONS

(71) Applicant: QUALCOMM Incorporated, San Diego, CA (US)

(72) Inventors: Abhishek Pramod PATIL, San Diego, CA (US); Sanket Sanjay KALAMKAR, San Diego, CA (US); Youhan KIM, Saratoga, CA (US); Naveen Kumar KAKANI, Flower Mound, TX (US); Alfred ASTERJADHI, San Diego, CA (US); Gaurang NAIK, San Diego, CA (US); George CHERIAN, San Diego, CA (US); Giovanni CHISCI, San Diego, CA (US); Sherief HELWA, San Diego, CA (US); Sai Yiu Duncan HO, San Diego, CA (US); Sameer VERMANI, San Diego, CA (US); Jialing Li CHEN, San Diego, CA (US)

(21) Appl. No.: 18/936,833

(22) Filed: Nov. 4, 2024

(51) Int. Cl. H04L 5/00

(52) U.S. Cl. CPC H04L 5/0044

(57) ABSTRACT

This disclosure provides methods, components, devices and systems for communications between access points with different channel configurations. Some aspects more specifically relate to performing a CAP procedure including coordinating APs with different primary channels. In some examples, a first access point (AP) may transmit, to one or more second APs, a physical protocol data unit (PPDU) including information associated with coordination of resources for a coordinated access point (CAP) procedure. At least a portion of the PPDU may be duplicated and transmitted via respective subchannels of at least a portion of a first bandwidth associated with the first AP based on the PPDU including the information associated with the coordination of resources for the CAP procedure. The first AP may communicate with the one or more second APs based on the information associated with the coordination and included in the PPDU.

### TECHNICAL FIELD

This disclosure relates generally to wireless communication and, more specifically, to communications between access points with different channel configurations.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a first access point (AP). The method may include transmitting, to one or more second APs, a physical protocol data unit (PPDU) including information associated with coordination of resources for a coordinated AP (CAP) procedure, where at least a portion of the PPDU is duplicated and transmitted via respective subchannels of at least a portion of a first bandwidth associated with the first AP based on the PPDU including the information associated with the coordination of resources for the CAP procedure and communicating with the one or more second APs based on the information associated with the coordination and included in the PPDU.

A first AP is described. The first AP may include a processing system that includes processor circuitry and memory circuitry that stores code. The processing system may be configured to cause the first AP to transmit, to one or more second APs, a PPDU including information associated with coordination of resources for a CAP procedure, where at least a portion of the PPDU is duplicated and transmitted via respective subchannels of at least a portion of a first bandwidth associated with the first AP based on the PPDU including the information associated with the coordination of resources for the CAP procedure and communicate with the one or more second APs based on the information associated with the coordination and included in the PPDU.

Another first AP is described. The first AP may include means for transmitting, to one or more second APs, a PPDU including information associated with coordination of resources for a CAP procedure, where at least a portion of the PPDU is duplicated and transmitted via respective subchannels of at least a portion of a first bandwidth associated with the first AP based on the PPDU including the information associated with the coordination of resources for the CAP procedure and means for communicating with the one or more second APs based on the information associated with the coordination and included in the PPDU.

A non-transitory computer-readable medium storing code is described. The code may include instructions executable by one or more processors to transmit, to one or more second APs, a PPDU including information associated with coordination of resources for a CAP procedure, where at least a portion of the PPDU is duplicated and transmitted via respective subchannels of at least a portion of a first bandwidth associated with the first AP based on the PPDU including the information associated with the coordination of resources for the CAP procedure and communicate with the one or more second APs based on the information associated with the coordination and included in the PPDU.

In some examples of the method, first APs, and non-transitory computer-readable medium described herein, transmitting the PPDU may include operations, features, means, or instructions for transmitting duplicate versions of an entirety of the PPDU via the respective subchannels of at least the portion of the first bandwidth associated with the first AP based on the PPDU being a control frame associated with the coordination of the resources for the CAP procedure.

In some examples of the method, first APs, and non-transitory computer-readable medium described herein, transmitting the PPDU may include operations, features, means, or instructions for transmit the PPDU via the respective subchannels of an entirety of the first bandwidth associated with the first AP based on the PPDU being the initial control frame and being addressed to one or more stations (STAs) serviced by the first AP.

In some examples of the method, first APs, and non-transitory computer-readable medium described herein, transmitting the PPDU may include operations, features, means, or instructions for transmitting the PPDU via the respective subchannels of the portion of the first bandwidth that overlaps with a second bandwidth of a second AP of the one or more second APs based on the PPDU being addressed to the second AP.

In some examples of the method, first APs, and non-transitory computer-readable medium described herein, transmitting the PPDU may include operations, features, means, or instructions for transmitting the PPDU that includes one or more resource unit (RU) allocations for one or more receiving devices, where the one or more RU allocations may be configured with reference to a primary channel of the first AP.

In some examples of the method, first APs, and non-transitory computer-readable medium described herein, transmitting the PPDU may include operations, features, means, or instructions for transmit the PPDU via the respective subchannels of the portion of the first bandwidth that overlaps with a second bandwidth of a second AP of the one or more second APs or via the respective subchannels of the portion that may be less than an overlapping portion between the first bandwidth and the second bandwidth based on the control frame including the resource allocation frame.

Some examples of the method, first APs, and non-transitory computer-readable medium described herein may further include operations, features, means, or instructions for receiving, from a second AP of the one or more second APs, a resource allocation frame including first information associated with the coordination of the resources, and where to transmit the PPDU, the processing system may be further configured to cause the first AP to and transmitting, based on receiving the resource allocation frame, the PPDU as a response to the resource allocation frame and via the respective subchannels of the portion occupying a second bandwidth allocated via the resource allocation frame or the portion of the second bandwidth allocated via the resource allocation frame that may be available for use by the first AP, the response including the information that may be second information associated with the coordination of the resources.

In some examples of the method, first APs, and non-transitory computer-readable medium described herein, transmitting the PPDU may include operations, features, means, or instructions for transmit the PPDU via the respective subchannels of the portion of bandwidth used during a transmission opportunity (TXOP) and returned via the resource return frame.

In some examples of the method, first APs, and non-transitory computer-readable medium described herein, transmitting the PPDU may include operations, features, means, or instructions for transmitting the PPDU that includes a duration field and one or more address fields that may be indicative of whether one or more receiving devices may be to configure an intra-basic service set (BSS) network allocation vector (NAV) associated with a value of the duration field for the CAP procedure.

In some examples of the method, first APs, and non-transitory computer-readable medium described herein, transmitting the PPDU may include operations, features, means, or instructions for transmitting the PPDU that includes an indication of the first bandwidth associated with the first AP.

In some examples of the method, first APs, and non-transitory computer-readable medium described herein, the indication may be carried via one or more fields of the PPDU.

In some examples of the method, first APs, and non-transitory computer-readable medium described herein, the PPDU includes a non-high-throughput duplicate (non-HT duplicate) PPDU frame format based on the PPDU being the control frame.

In some examples of the method, first APs, and non-transitory computer-readable medium described herein, transmitting the PPDU may include operations, features, means, or instructions for transmitting duplicate versions of the portion of the PPDU via the respective subchannels of at least the portion of the first bandwidth associated with the first AP based on the PPDU being a management frame associated with the coordination of the resources for the CAP procedure and transmitting a header of the PPDU via an entirety of the first bandwidth associated with the first AP based on the PPDU being the management frame associated with the coordination of the resources for the CAP procedure.

In some examples of the method, first APs, and non-transitory computer-readable medium described herein, the duplicate versions of the portion include duplicate versions of a preamble of the PPDU.

In some examples of the method, first APs, and non-transitory computer-readable medium described herein, the duplicate versions of the preamble include an uplink/downlink bit that may be set to a value of one to indicate that the PPDU may be addressed to the one or more second APs.

In some examples of the method, first APs, and non-transitory computer-readable medium described herein, the duplicate versions of the preamble include a BSS color field.

In some examples of the method, first APs, and non-transitory computer-readable medium described herein, the BSS color field included in the duplicate versions of the preamble includes a value of zero that indicates that the PPDU may be transmitted by the first AP that may be unassociated with a receiving device.

In some examples of the method, first APs, and non-transitory computer-readable medium described herein, the BSS color field included in the duplicate versions of the preamble includes a value that indicates a CAP procedure type of the CAP procedure.

In some examples of the method, first APs, and non-transitory computer-readable medium described herein, the BSS color field included in the duplicate versions of the preamble includes a value indicative of a set of multiple CAP procedure types.

In some examples of the method, first APs, and non-transitory computer-readable medium described herein, the duplicate versions of the preamble include an indication of a type of the PPDU, an indication compression mode for the PPDU, or both.

In some examples of the method, first APs, and non-transitory computer-readable medium described herein, the duplicate versions of the preamble include an indication of a STA identifier with a value of a first identifier of the first AP assigned by a second AP of the one or more second APs, or a first value indicative of a CAP procedure type of the CAP procedure, or a second value indicative of a set of multiple CAP procedure types.

In some examples of the method, first APs, and non-transitory computer-readable medium described herein, the header of the PPDU transmitted via the entirety of the first bandwidth includes a frame type identifier or frame subtype identifier indicative of a coordination access procedure access frame, a first field indicative of a first address of the first AP, a second field indicative of a second address of a second AP of the one or more second APs, or a combination thereof.

In some examples of the method, first APs, and non-transitory computer-readable medium described herein, the management frame includes a unicast frame associated with negotiation of the CAP procedure, associated with cancellation of the CAP procedure, or both.

In some examples of the method, first APs, and non-transitory computer-readable medium described herein, transmitting the PPDU may include operations, features, means, or instructions for transmitting the PPDU as a single user (SU) frame format based on the PPDU being the management frame.

Some examples of the method, first APs, and non-transitory computer-readable medium described herein may further include operations, features, means, or instructions for receiving, from a second AP of the one or more second APs, a first PPDU within the portion of the first bandwidth that overlaps with a second bandwidth of the second AP, where transmitting the PPDU as a second PPDU includes and transmitting the second PPDU including feedback associated with the first PPDU via the portion of the first bandwidth.

Some examples of the method, first APs, and non-transitory computer-readable medium described herein may further include operations, features, means, or instructions for receiving, from a second AP of the one or more second APs, a first PPDU that includes an allocation of a resource for transmission of feedback associated with the first PPDU, where to transmit the PPDU as a second PPDU, the processing system may be further configured to cause the first AP to and transmitting the second PPDU including the feedback associated with the first PPDU via the allocated resource.

In some examples of the method, first APs, and non-transitory computer-readable medium described herein, the allocated resources may be associated with a primary channel of the second AP.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows a frequency diagram depicting an example distributed tone mapping.

FIG. 6 shows a pictorial diagram of another example wireless communication network.

FIG. 7 shows an example of a signaling diagram that supports communications between access points with different channel configurations.

FIG. 8 shows an example of a communication sequence that supports communications between access points with different channel configurations.

FIG. 9 shows an example of channel configurations that support communications between access points with different channel configurations.

FIG. 10 shows an example of a process flow that supports communications between access points with different channel configurations.

FIG. 11 shows a block diagram of an example wireless communication device that supports communications between access points with different channel configurations.

FIGS. 12 through 14 show flowcharts illustrating example processes performable by or at a first access point that supports communications between access points with different channel configurations.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, access points may coordinate communications using various coordinated access point (CAP) procedures, which may be used to allocate resources for communications with stations. For example, a coordinated time-division-multiple-access (C-TDMA) procedure may be used to allocate resources of a transmission opportunity (TXOP) between a sharing access point (such as the access point that initiates the procedure) and a shared access point (AP) (such as the access point that receives the resource allocation from the sharing access point). APs may be configured to utilize primary channels (such as a 20 MHz subchannel of an operating bandwidth) for various control procedures. Utilization of primary channels may support reduction of resource overhead associated with monitoring of full channel bandwidths by APs or wireless stations (STAs). However, APs may utilize different operating channels and/or different primary channels, which may be fully or partially overlapping.

Various aspects described herein relate generally to communications between APs for AP discovery and/or performing a CAP procedure, including coordinating APs with different primary channels. Some aspects more specifically relate to coordinating APs communicating information via duplicative and non-duplicative physical protocol data units (PPDU) formats. In some examples, At least a portion of a PPDU including a frame may be duplicated across multiple channels or subchannels of at least a portion of a bandwidth of a transmitting AP. In some examples, the portion that is duplicated may be dependent on whether the frame is a control frame or a management frame. For control frames, the entire PPDU may be duplicated across the multiple channels (such as via a non-high throughput (non-HT) duplicate PPDU format). Each channel may have a bandwidth of 20 MHz. For management frames, a preamble of the PPDU may be duplicated across the multiple channels (such as 20 MHz channels), and the data portion of the PPDU may be transmitted via the entire bandwidth (such as in non-duplicate format).

Particular aspects of the subject matter described in this disclosure can be implemented to realize one or more of the following potential advantages. In some examples, by communicating information via duplicative and non-duplicative PPDU formations, the described techniques can be used to improve communication efficiency and enable coordinating APs with different primary channels to perform a CAP procedure. While one or more aspects described herein relate to APs communicating to support CAP procedures, it should be understand that some aspects may relate to APs communicating separate from supporting CAP procedures. That is, some of the communications described herein may not be associated with coordinating or performing a CAP procedure between APs.

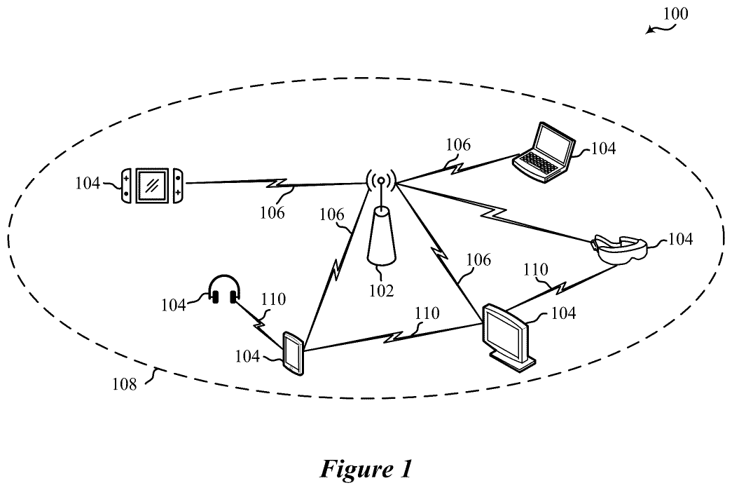

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless AP (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a BSS identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY PPDUs.

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4 -1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR-or IEEE 802.11bn-compatible) devices for opportunistic access to spectrum that may be otherwise under-utilized.

Puncturing is a wireless communication technique that enables a wireless communication device (such as either an AP 102 or a STA 104) to transmit and receive wireless communications over a portion of a wireless channel exclusive of one or more particular subchannels (hereinafter also referred to as “punctured subchannels”).

Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as an AP 102 or a STA 104) may puncture the subchannels on which there is interference and in essence spread the data of the PPDU to cover the remaining portion of the bandwidth of the channel. For example, if a transmitting device determines (such as detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while a UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

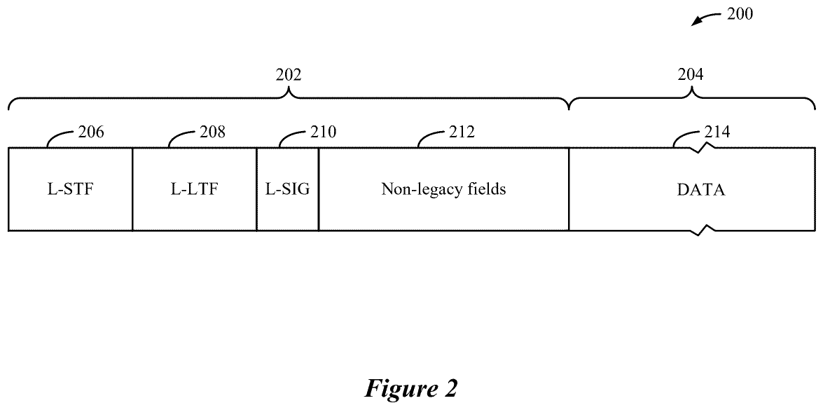

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

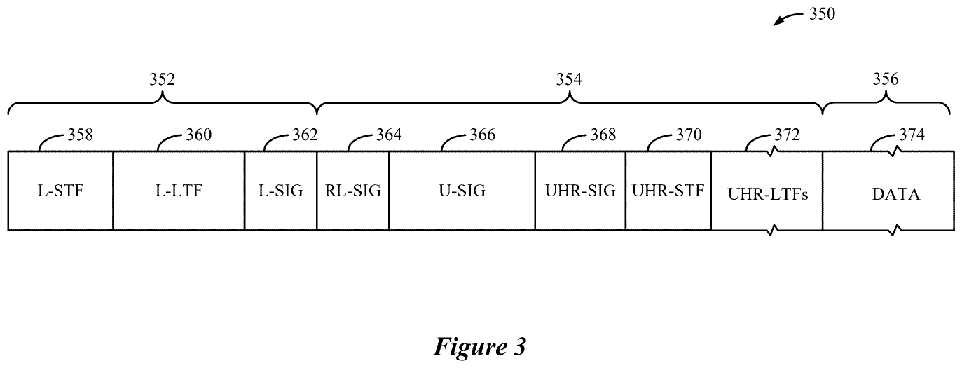

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364, a universal signal field 366 (referred to herein as “U-SIG 366”) and a UHR signal field 368 (referred to herein as “UHR-SIG 368”). The presence of RL-SIG 364 and U-SIG 366 may indicate to UHR or later version-compliant STAs 104 that the PPDU 350 is a UHR PPDU or a PPDU conforming to any later (post-UHR) version of a new wireless communication protocol conforming to a future IEEE 802.11 wireless communication protocol standard. One or both of U-SIG 366 and UHR-SIG 368 may be structured as, and carry version-dependent information for, other wireless communication protocol versions associated with amendments to the IEEE family of standards beyond UHR. For example, U-SIG 366 may be used by a receiving device (such as an AP 102 or a STA 104) to interpret bits in one or more of UHR-SIG 368 or the data field 374. U-SIG 366 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 366 and UHR-SIG 368 and additional information fields or single user (SU)-specific fields that may be useful to intended recipients. In some implementations, the version-dependent fields may include at least a PPDU format field to indicate a general PPDU format for the PPDU 350 (such as a trigger-based (TB), a single-user (SU), or a multi-user (MU) PPDU format). Like L-STF 358, L-LTF 360, and L-SIG 362, the information in U-SIG 366 and UHR-SIG 368 may be duplicated and transmitted in each of the component 20 MHz channels in instances involving the use of a bonded channel.

The non-legacy portion 354 further includes an additional short training field 370 (referred to herein as “UHR-STF 370,” although it may be structured as, and carry version-dependent information for, other wireless communication protocol versions beyond UHR) and one or more additional long training fields 372 (referred to herein as “UHR-LTFs 372,” although they may be structured as, and carry version-dependent information for, other wireless communication protocol versions beyond UHR). UHR-STF 370 may be used for timing and frequency tracking and AGC, and UHR-LTF 372 may be used for more refined channel estimation.

UHR-SIG 368 may be used by an AP 102 to identify and inform one or multiple STAs 104 that the AP 102 has scheduled uplink (UL) or downlink (DL) resources for them. UHR-SIG 368 may be decoded by each compatible STA 104 served by the AP 102. UHR-SIG 368 also may generally be used by the receiving device to interpret bits in the data field 374. For example, UHR-SIG 368 may include resource unit (RU) allocation information, spatial stream configuration information, and per-user (such as STA-specific) signaling information. Each UHR-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communications systems, a STA 104 or an AP 102 may transmit the PPDU 350 over bandwidths larger than the 20 MHz, 40 MHz, 80 MHz, 160 MHz, and 320 MHz bandwidths supported by previous generations of IEEE-compliant wireless communication systems. For example, the PPDU 350 may support 480 MHz or 640 MHz bandwidth communications. By increasing the channel bandwidth of the PPDU 350 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 370, UHR-LTFs 372, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 366 of an ELR PPDU 350 may include a first indication (such as a codepoint of a PHY version identifier subfield within a version-independent portion of the U-SIG 366 or a value of an ELR subfield within a version-dependent portion of the U-SIG 366) that the PPDU 350 is associated with an ELR format. The U-SIG 366 of an ELR PPDU 350 may include a second indication (such as a STA identifier subfield within the version-dependent portion of the U-SIG 366) of an intended receiver of the PPDU. In some examples, an ELR PPDU 350 may include an ELR-signature (ELR-SIG) field that includes an uplink/downlink indicator subfield, a length subfield, a coding indicator subfield, and a modulation and coding scheme (MCS) subfield.

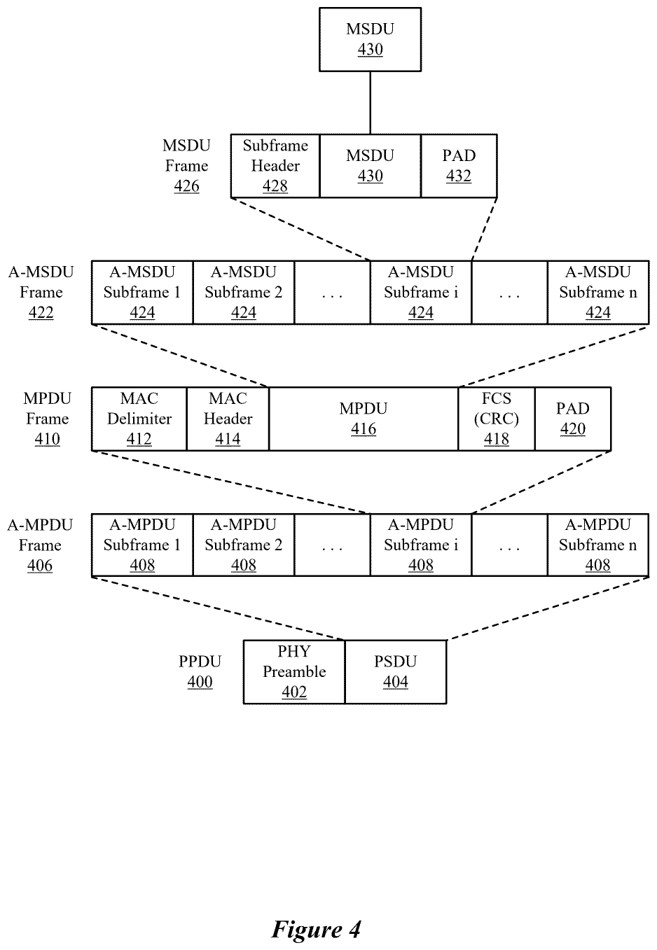

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 408 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (such as the FCS field 418 may include a cyclic redundancy check (CRC)) and padding bits 420. The MPDU 416 may carry one or more MAC service data units (MSDUs) 430. For example, the MPDU 416 may carry an aggregated MSDU (A-MSDU) 422 including multiple A-MSDU subframes 424. Each A-MSDU subframe 424 may be associated with an MSDU frame 426 and may contain a corresponding MSDU 430 preceded by a subframe header 428 and, in some examples, followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (such as the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs after receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described herein.

Retransmission protocols, such as hybrid automatic repeat request (HARQ), also may offer performance gains. A HARQ protocol may support various HARQ signaling between transmitting and receiving wireless communication devices (such as the AP 102 and the STAs 104 described with reference to FIG. 1) as well as signaling between the PHY and MAC layers to improve the retransmission operations in a wireless communication network. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a wireless communication network may improve reliability of data communicated from a transmitting device to a receiving device. The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (such as a negative acknowledgment (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an automatic repeat request (ARQ) protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

APs and STAs (such as the AP 102 and the STAs 104 described with reference to FIG. 1) that include multiple antennas may support various diversity schemes. For example, spatial diversity may be used by one or both of a transmitting device (such as an AP 102 or a STA 104) or a receiving device (such as an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space- time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally, or alternatively, involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (such as in the form of a null data packet (NDP)) to the beamformee. An NDP is a PPDU without any data field. The beamformee may perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (such as identify, detect, ascertain, calculate, or compute) how to transmit a signal on each of its antennas to perform beamforming. For example, the steering matrix may be indicative of a phase shift, or a power level, to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communications to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

A wireless communication device may include an auxiliary radio and a main radio and may operate in both an auxiliary radio mode and a main radio mode. The wireless communication device may be a STA or an AP, such as, for example, the AP 102 and STAs 104 described with reference to FIG. 1. Additionally, the wireless communication device may support communications over a single wireless link or over multiple wireless links. For example, the wireless communication device may be an AP MLD or a non-AP MLD. The auxiliary radio mode may support communications with relatively lower data rates (such as ≤24 Mbps) than the main radio mode. For example, while operating in an auxiliary radio mode, the auxiliary radio of the wireless communication device may transmit messages having a non-HT format whereas, while operating in a main radio mode, the main radio may transmit messages having an EHT, UHR or later protocol format. A wireless communication device that uses an auxiliary radio in addition to a main radio may improve reliability and reduce latency and power consumption. For example, the wireless communication device may improve reliability by using the auxiliary radio to transmit/receive redundancies, facilitate fast feedback exchanges, or otherwise increase robustness for high-priority or otherwise important packets (such as packets containing latency-sensitive traffic or traffic requiring high reliability). For example, to support latency-sensitive traffic insertion in uplink communications, an AP may utilize its auxiliary radio for detection of low latency PPDU (LL-PPDU) subframes associated with latency-sensitive traffic. As another example, the wireless communication device also may use the auxiliary radio to scan for channels while communicating on another channel via the main radio, thereby reducing latency associated with a transition between channels by eliminating the time for the main radio to scan for channels. As another example, use of the auxiliary radio may reduce power consumption by enabling the main radio to enter a sleep mode and monitoring for wake-up signals via the auxiliary radio, which is designed to consume less power than the main radio.

The auxiliary radio may support both transmitting and receiving (Tx/Rx) modes of operation, or may support receiving-only (Rx-only) modes of operation. If the wireless communication device is an MLD, the wireless communication device may communicate on one or more wireless links using a main radio and may simultaneously communicate on one or more wireless links using one or more auxiliary radios. In an MLD scenario in which the auxiliary radio is Rx-only capable (an “Aux-Rx” mode), the wireless communication device may transmit and receive communications on a first wireless link using the main radio but may simultaneously receive (but not transmit) communications on a second wireless link using the auxiliary radio. In an MLD scenario in which the auxiliary radio is Tx/Rx capable (an “Aux-Tx/Rx” mode), the wireless communication device may transmit and receive communications on a first wireless link using the main radio and may simultaneously transmit and receive communications on a second wireless link using the auxiliary radio. In an MLD scenario, the wireless communication device may transition the main radio from a second wireless link to a first wireless link and may correspondingly transition the auxiliary radio from the first wireless link to the second wireless link. For example, the wireless communication device's auxiliary radio may receive control signaling on the second wireless link from another wireless communication device that triggers the wireless communication device to switch the use of its radios between wireless links. If the wireless communication device is not an MLD, the wireless communication device may transition from using its auxiliary radio to using its main radio mode on a single wireless link. For example, the wireless communication device's auxiliary radio may receive control signaling from another wireless communication device that triggers the wireless communication device to initiate the transition from use of the auxiliary radio to the main radio on the wireless link. after such a transition, the wireless communication device may place the auxiliary radio in a powered-down sleep state while activating the main radio to an awake state. Similarly, the wireless communication may transition from using its main radio to its auxiliary radio on the wireless link after receiving a triggering control signal.

In some examples, the wireless communication device (such as a STA) may indicate (such as via a broadcast frame such as a beacon frame or other management frame), to other wireless communication devices (such as an AP), parameters associated with an auxiliary radio mode or parameters associated with transitioning from the auxiliary radio mode to a main radio mode for a given wireless link. For example, the wireless communication device may indicate a message format for the auxiliary radio mode. The indicated message format may be associated with a particular PPDU format (such as non-HT) or a supported data rate (such as ≤24 Mbps).

In some examples, the wireless communication device may indicate transition delays corresponding to time durations associated with switching from the auxiliary mode to the main radio mode as well as switching from the main radio mode to the auxiliary radio mode for a wireless link. A second wireless communication device may schedule data communications with the wireless communication device based on the transition delay so that data is not transmitted to the wireless communication device during the transition delay, during which data may be lost. The duration of the transition delay may generally be dependent on whether the auxiliary radio supports Tx/Rx or Rx-only modes of operation. For example, if the auxiliary radio supports Tx/Rx, the auxiliary radio may transmit an acknowledgment message in response to a request to transition to the main radio mode for a wireless link, which may extend the transition delay. Additionally, or alternatively, the duration of the transition delay may depend on whether the main radio is transitioning from a sleep mode or from a different wireless link.

The auxiliary radio may perform additional functions while the wireless communication device communicates with a second wireless communication device via a wireless link using the main radio. The functions that may be performed may generally depend on whether the auxiliary radio supports Tx/Rx or Rx-only modes of operation or whether the wireless communication device is an MLD capable of supporting communications over more than one wireless link. For example, in an Aux-Rx mode, the auxiliary radio of a wireless communication device (such as a non-AP MLD) may monitor or collect channel state (or quality) information or statistics (such as BSS load, interference profiles of neighboring BSSs and multi-NAV multi-primary maintenance) in a passive manner. In an Aux Tx/Rx mode, the auxiliary radio of the non-AP MLD may monitor or collect channel state information or statistics as well as transmit a report to an AP MLD that includes the collected channel state information or statistics without involvement of the main radio. In some examples, while operating in an Aux-Rx mode, a first wireless communication device (such as an AP MLD) may use the auxiliary radio to receive control communications or high-priority or otherwise important data communications from the second wireless communication device (such as another AP MLD) using a second wireless link while its main radio uses the first wireless link to perform data transfer. In contrast, in an Aux-Tx/Rx mode, an AP MLD may use the auxiliary radio to both receive and transmit control communications or high-priority or otherwise important data communications. In some examples, while operating in an Aux-Rx mode, a non-AP MLD's auxiliary radio may monitor or scan for potential APs to associate with on alternative wireless channels than the wireless channel on which the non-AP MLD's main radio is still communicating with a previously connected AP. In an Aux-Tx/Rx mode, an MLD may use the auxiliary radio to both scan for and perform association or authentication on other wireless channels.

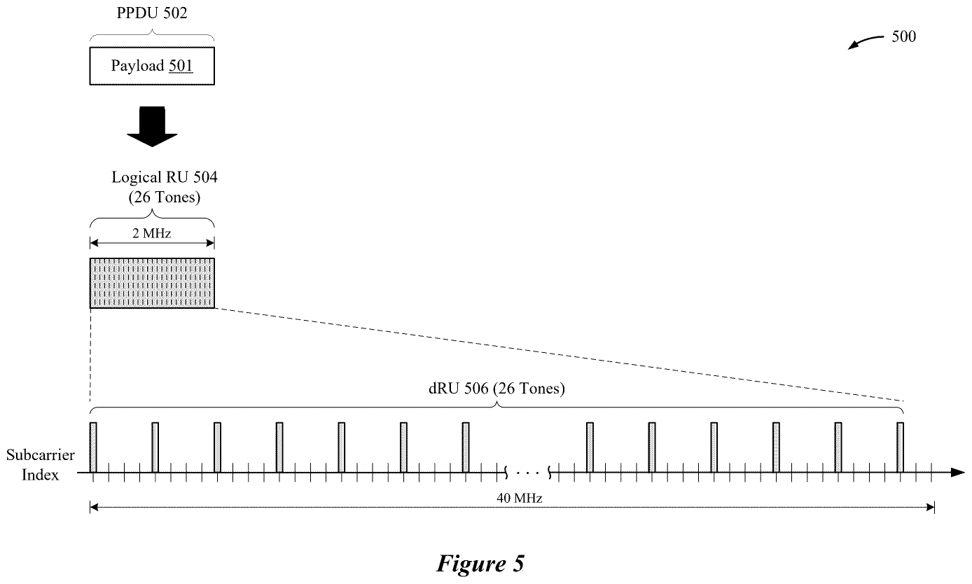

FIG. 5 shows a frequency diagram 500 depicting an example distributed tone mapping. More specifically, FIG. 5 shows an example mapping of how the tones of a payload 501 of a PPDU 502 are distributed for transmission over a spreading bandwidth of a wireless channel. In the illustrated example, the tones in a logical RU 504 (which may represent an rRU of non-distributed tones in accordance with a legacy tone plan) associated with payload 501 are mapped to a distributed RU (dRU) 506 in accordance with a distributed tone plan.

Aspects of the present disclosure recognize that by distributing the tones across a wider bandwidth, the per-tone transmit power of a logical RU 504 may be increased to provide greater flexibility in medium utilization for PSD-limited wireless channels. For example, when mapped to an rRU such as logical RU 504, the transmit power of the logical RU 504 may be severely limited based on the PSD of the wireless channel. For example, the LPI power class limits the transmit power of APs 102 and STAs 104 to 5 dBm/MHz and −1 dBm/MHz, respectively, in the 6 GHz band. As such, the per-tone transmit power of the logical RU 504 is limited by the number of tones mapped to each 1 MHz subchannel of the wireless channel.

By enabling a STA 104 to map modulation symbols in a distributed manner onto noncontiguous tones interspersed throughout all or a portion of a wireless channel, distributed transmissions may enable an increase in the per-tone transmit power used for each individual distributed tone, and thus the overall transmit power of the PPDU 502, without exceeding the PSD limits of the wireless channel. As shown in the example of FIG. 5, the STA 104 may map logical RU 504 to a set of 26 noncontiguous subcarrier indices spread across a 40 MHz wireless channel (also referred to herein as a “spreading bandwidth”). Compared to the tone mapping described above with respect to the legacy tone plan, the distributed tone mapping depicted in FIG. 5 effectively reduces the number of tones (of the logical RU 504) in each 1 MHz subchannel. For example, each of the 26 tones can be mapped to a different 1 MHz subchannel of the 40 MHz channel. As a result, each AP 102 or STA 104 implementing the distributed tone mapping of FIG. 5 can maximize its per-tone transmit power (which may maximize the overall transmit power of the logical RU 504).

In some examples (not shown in FIG. 5), multiple logical RUs may be mapped to interleaved subcarrier indices of a shared wireless channel. For example, a STA 104 may modulate a portion of the symbols on a number of tones representing multiple logical RUs to noncontiguous subcarrier indices associated with a shared wireless channel in accordance with a distributed tone plan. Furthermore, distributed transmissions by multiple STAs 104 may be multiplexed onto different sets of distributed tones of a shared wireless channel such as to enable an increase in the transmit power of each device without sacrificing spectral efficiency. Such increases in transmit power can be combined with some MCSs to increase the range and throughput of wireless communications on PSD-limited wireless channels. Distributed transmissions also may improve packet detection and channel estimation capabilities.

To support distributed transmissions, new packet designs and signaling may be used to indicate whether a PPDU 502 is transmitted on tones spanning an rRU, such as a logical RU 504 (according to a legacy tone plan), or a dRU 506 (according to a distributed tone plan). For example, the IEEE 802.11be standard amendment or earlier versions of the IEEE 802.11 family of wireless communication protocol standards define a trigger frame format which can be used to solicit the transmission of a trigger-based (TB) PPDU from one or more STAs 104. The trigger frame allocates resources to the STAs 104 for the transmission of the TB PPDU and indicates how the TB PPDU is to be configured for transmission. For example, the trigger frame may indicate a logical RU or MRU allocated for transmission in the TB PDDU. In some examples, the trigger frame may be further configured to carry tone distribution information indicating whether the logical RU (or MRU) maps to an rRU or a dRU.

In some implementations, a STA 104 may include a distributed tone mapper that maps the logical RU 504 to the dRU 506 in the frequency domain. The dRU 506 is converted to a time-domain signal (such as by an inverse fast Fourier transform (IFFT)) for transmission over a wireless channel. The AP 102 may receive the time-domain signal and reconstruct the dRU 506 (such as by a fast Fourier transform (FFT)). In some implementations, the AP 102 may include a distributed tone demapper that demaps the dRU 506 to the logical RU 504. In other words, the distributed tone demapper reverses the mapping performed by the distributed tone mapper at the STA 104. The AP 102 can recover the information carried (or modulated) on the logical RU 504 as a result of the demapping.

In the example of FIG. 5, the logical RU 504 is distributed evenly across the spreading bandwidth. While the example shown in FIG. 5 illustrates a spreading bandwidth of 40 MHz, spreading bandwidths also may include 80 MHz, 160 MHz, or 320 MHz. In some implementations, the logical RU 504 can be mapped to any suitable pattern of noncontiguous subcarrier indices. For example, in various implementations, the distance between any pair of adjacent modulated tones may be less than or greater than the distances depicted in FIG. 5.

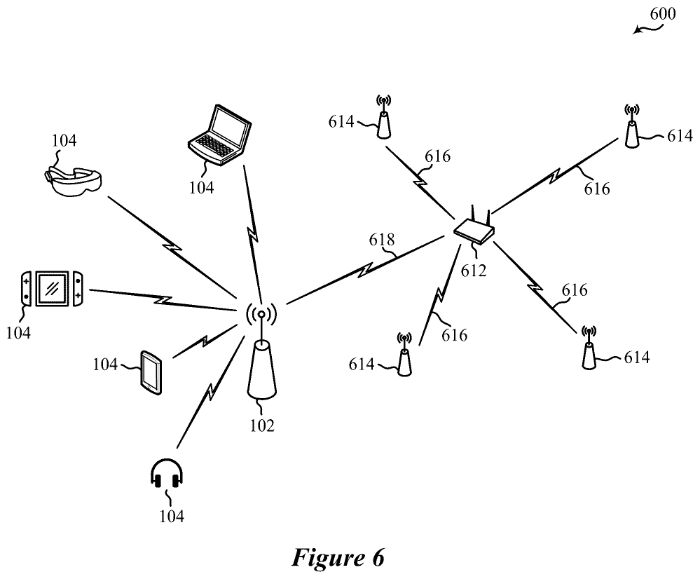

FIG. 6 shows a pictorial diagram of another example wireless communication network 600. According to some aspects, the wireless communication network 600 can be an example of a mesh network, an IoT network, or a sensor network in accordance with one or more of the IEEE 802.11 family of wireless communication protocol standards (including the 802.11ah amendment). The wireless communication network 600 may include multiple wireless communication devices 614, which in some implementations may include APs 102, STAs 104, or both. The wireless communication devices 614 may represent various devices such as display devices (such as TVs, computer monitors, navigation systems, among others), music or other audio or stereo devices, remote control devices (“remotes”), printers, kitchen or other household appliances, among other examples.

In some examples, the wireless communication devices 614 sense, measure, collect or otherwise obtain and process data and transmit such raw or processed data to an intermediate device 612 for subsequent processing or distribution. Additionally, or alternatively, the intermediate device 612 may transmit control information, digital content (such as audio or video data), configuration information or other instructions to the wireless communication devices 614. The intermediate device 612 and the wireless communication devices 614 can communicate with one another via wireless communication links 616. In some examples, the wireless communication links 616 include Bluetooth links or other PAN or short-range communication links.

In some examples, the intermediate device 612 also may be configured for wireless communication with other networks such as with a WLAN or a wireless (such as cellular) wide area network (WWAN), which may, in turn, provide access to external networks including the Internet. For example, the intermediate device 612 may associate and communicate, over a Wi-Fi link 618, with an AP 102 of a wireless communication network 600, which also may serve various STAs 104. In some examples, the intermediate device 612 is an example of a network gateway, for example, an IoT gateway. In such a manner, the intermediate device 612 may serve as an edge network bridge providing a Wi-Fi core backhaul for the IoT network including the wireless communication devices 614. In some examples, the intermediate device 612 can analyze, preprocess and aggregate data received from the wireless communication devices 614 locally at the edge before transmitting it to other devices or external networks via the Wi-Fi link 618. The intermediate device 612 also can provide additional security for the IoT network and the data it transports.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

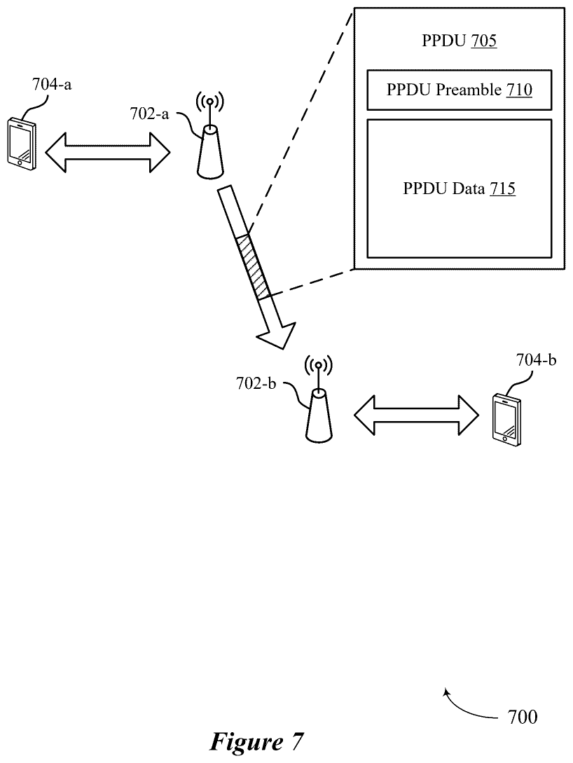

FIG. 7 shows an example of a signaling diagram 700 that supports communications between APs with different channel configurations. The signaling diagram 700 may include APs 702 (such as a first AP 702-a and a second AP 702-b) and the STAs 704 (such as a first STA 704-a and a second STA 704-b). The APs 702 may be examples of the APs described with respect to FIG. 1 -6, and the STAs 704 may be examples of the STAs described with respect to FIG. 1 -6. The APs 702 and the STAs 704 may communicate in accordance with a CAP procedure or may communicate separate from a CAP procedure.

The CAP procedure may involve the first AP 702-a sharing a portion of communication resources (such as of a TXOP) with one or more other APs 702, such as the second AP 702-b, in a coverage area (e.g. in a neighborhood). For example, various CAP procedures may involve the first AP 702-a sharing time domain resources, frequency domain resources, spatial resources, beamforming resource, or any combination thereof, with the second AP 702-b. In accordance with a C-TDMA procedure, the first AP 702-a coordinates and shares time domain resources with the second AP 702-b.

In accordance with the various CAP procedures or other communications, the first AP 702-a and the second AP 702-b may exchange various control frames, management frames, and/or data frames. The APs 702 may transmit the frames via a physical packet data unit (PPDU). For example, the first AP 702-a and the second AP 702-b may exchange management frames to perform AP discovery operations, coordinate a CAP procedure, and/or to execute the CAP procedure. The first AP 702-a may determine a capabilities of the second AP 702-b based on a contents of one or more broadcast management frames. For example, the first AP 702-a may determine a capability of the second AP 702-b to participate in a CAP procedure. The first AP 702-a may determine updates to capabilities or operational parameters of the second AP 702-b based on one or more broadcast management frames. The first AP 702-a may exchange management frames with the second AP 702-b to establish a long-term CAP agreement (such as a C-TDMA agreement). Additionally, The first AP 702-a may exchange control frames with the second AP 702-b during a coordinated TXOP as part of a C-TDMA agreement.

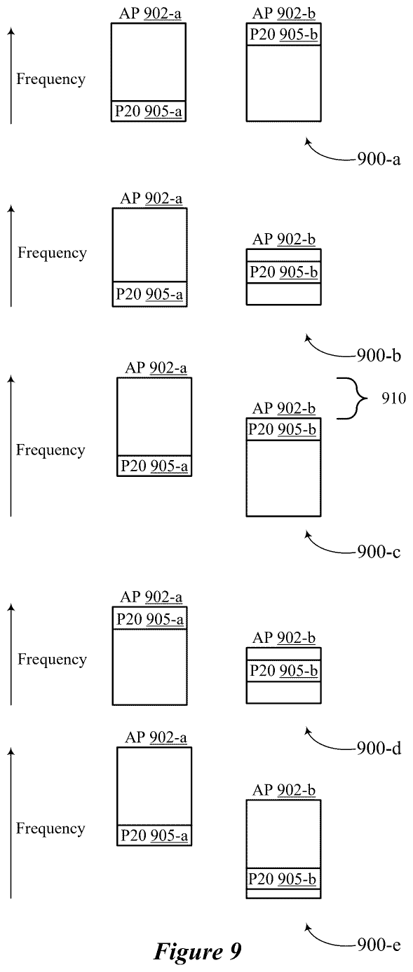

An AP 702, such as the first AP 702-a or the second AP 702-b, may be configured to monitor a primary channel for frame communication. The primary channel may be within a total bandwidth that the AP 702 is capable of transmitting and receiving via (such as an operating bandwidth). In some examples, the first AP 702-a and the second AP 702-b may utilize different operating bandwidths, different primary channels, or both, which may be fully or partially overlapping. The APs 702 may perform a CAP procedure (such as C-TDMA operations) regardless of whether the first AP 702-a and the second AP 702-b share the same primary channel. For example, the APs 702 may perform a CAP procedure when the participating APs 702 do not share a same primary 20 MHz channel (sometimes referred to as P20). The APs 702 may perform the CAP procedure based on the primary channel (such as P20) of the first AP 702-a and the primary channel of the second AP 702-b being positioned within the overlapping portion of the respective operating bandwidths of the two APs 702, as described with reference to FIG. 9.

In some examples, the first AP 702-a and the second AP 702-b may exchange frames to support AP discovery operations. The two APs 702 that operate on different primary channels (such as P20) within an overlapping bandwidth may discover one or more APs 702 based on receiving an indication of the one or more APs 702. In some examples, an AP 702, such as the first AP 702-a or the second AP 702-b, may transmit a broadcast frame (such as a broadcast frame carrying CAP information) via a PPDU in a non-HT duplicate frame format. In accordance with the non-HT duplicate frame format, the AP 702 may transmit the broadcast frame via multiple subchannels within an operating bandwidth of the AP 702. For example, to support AP discovery, the first AP 702-a may transmit a non-HT duplicate PPDU including the broadcast frame via each subchannel (such as each 20 MHz subchannel) within the operating bandwidth of the first AP 702-a. Since the operating bandwidth of the first AP 702-a overlaps with the primary channel of the second AP 702-b, the second AP 702-b may receive the broadcast frame via the primary channel of the second AP 702-b. As such, transmission of frames via a non-HT duplicate PPDU format may support APs communicating even though they may have different primary channels. However, transmissions in non-HT dup PPDU format may be inefficient as the same broadcast frame or content of the broadcast frames may be duplicated and transmitted via multiple subchannels. Additionally, or alternatively, a recipient, such as the second AP 702-b, may not be able to determine the P20 of a transmitter, such as the first AP 702-a, and a response (such as an acknowledgement) sent by the recipient may not be sent via the P20 of the transmitter. For example, the recipient may transmit the response via a P20 of the recipient, and the P20 of the recipient may be different than the P20 of the transmitter. Thus, some limitations may be applied to types of frames that may be transmitted via non-HT duplicate PPDU format. The techniques described herein support APs exchanging frames in non-HT duplicate PPDU format and other formats such as to support AP coordination and communication, while also improving communication efficiency.

In some examples, the APs 702 may be configured to transmit the broadcast frame via format other than a non-HT duplicate PPDU format. In such cases, to support AP discovery, the first AP 702-a may be configured to monitor an operating bandwidth of the first AP 702-a to receive a broadcast frame from another AP 702 with a different primary bandwidth. In a first option of AP discovery without using a broadcast frame in non-HT duplicate PPDU format, the first AP 702-a may periodically perform an off-channel scan (such as off primary channel scan) on different channels or subchannels within the operating bandwidth of the first AP 702-a to discover other APs 702 that are capable of a CAP operations (such as C-TDMA procedure). Prior to the AP 702 performing the off-channel scan, the first AP 702-a may indicate unavailability on the primary channel of the first AP 702-a. For example, the first AP 702 may employ techniques such as a broadcast target wake time (bTWT) or dedicated service periods (DPS) to notify other receiving devices (such as STAs 704 and other APS 702) that the first AP 702-a is unavailable during the off-channel scan.

In some examples, the APs 702 may communicate via a backhaul connection. For example, the first AP 702-a and the second AP 702-b may belong to the same operator, or the first AP 702-a and the second AP 702-b may be included in a managed deployment. A centralized controller may configure or orchestrate a coordination between the APs 702. An AP 702 may receive an indication of a primary channel (such as a P20) of another AP 702 via the backhaul connection. For example, the first AP 702-a may transmit an indication of the primary channel of the first AP 702-a to the second AP 702-b via the backhaul connection and/or via the centralized controller.

In a second option of AP discovery without using a broadcast frame in non-HT duplicate PPDU format, the first AP 702-a may transmit an indication for one or more other wireless devices (such as STAs 704) to perform an off-channel scan and report identified APs 702 to the first AP 702-a. In some examples, the first AP 702-a may involve one or more associated non-AP STAs (such as the first STA 704-a) by requesting the one or more non-AP STAs to scan different channels within the operating bandwidth of the first AP 702-a to discover other APs 702. The first AP 702-a may request the one or more non-AP STAs to filter based on presence of at least some fields within the beacon of the neighboring APs. For example, the first AP 702-a may request the one or more non-AP STAs to report CAP information associated with other APs 702, perform off-channel scans periodically, or perform off-channel scans for a specified duration. The request may be in an example of a beacon report request (such as a 802.11k beacon report request) or an event report. In a third option of AP discovery without using a broadcast frame in non-HT duplicate PPDU format, the first AP 702-a may employ an auxiliary radio to perform an off-channel scan for broadcast frames. The first AP 702-a may continue to monitor the primary channel (such as P20) via a primary radio for CAP discovery purposes. In other words, an auxiliary radio scheme may not move the primary radio away from the primary channel of the first AP 702-a for CAP discovery. The auxiliary radio may monitor subchannels within the operating bandwidth of the first AP 702-a, and the auxiliary radio may output an indication of other APs 702 or CAP information associated with the other APs 702 to the first AP 702-a. In some examples, the auxiliary radio is a low-power or low-capability radio that may be used for various services such as AP discovery.

As described herein, the first AP 702-a may exchange frames with the second AP 702-b as part of the CAP procedure (such as coordination of or execution of the CAP procedure). CAP advertisements and negotiations may involve management frames. Additionally, or alternatively, the first AP 702-a may communicate with the second AP 702-b via control frames (such as during a TXOP). For example, during a CAP TXOP (such as C-TDMA), the frames may be mostly control frames. A scheduling announcement frame may be a multi-station block acknowledgment (MBA) frame carrying resource request information. A response to a TXOP frame may be a clear-to-send (CTS) frame, and a TXOP return frame may be a management frame or an MBA frame. Data frames may not be exchanged between AP 702 for CAP procedures.

According to techniques described herein, the first AP 702-a or the second AP 702-b may transmit information via duplicative and non-duplicative PPDU formats. At least a portion of a PPDU including a frame may be duplicated across multiple channels or subchannels of at least a portion of a bandwidth of a transmitting AP 702. The portion that is duplicated may be dependent on whether the frame is a control frame or a management frame. For control frames, the entire PPDU may be duplicated across the multiple channels (such as via a non-HT duplicate PPDU format). For management frames, a preamble of the PPDU may be duplicated across the multiple channels, and the header portion (such as MAC-CE header) of the PPDU may be transmitted via the entire bandwidth (such as in non-duplicate format).

In some examples, the first AP 702-a may transmit a control frame to the second AP 702-b. The first AP 702-a may transmit duplicative PPDUs 705 via multiple subchannels within the operating bandwidth of the first AP 702-a. The second AP 702-b may receive the PPDU 705 via a subchannel corresponding to a primary channel of the second AP 702-b based on the operating bandwidth of the first AP 702-a overlapping with the primary channel of the second AP 702-b. In some examples, the first AP 702-a may transmit a management frame to the second AP 702-b. The first AP 702-a may transmit multiple PPDUs 705 including the management frame via multiple subchannels via an overlapping bandwidth between the operating bandwidth of the first AP 702-a and the operating bandwidth of the second AP 702-b. The multiple PPDUs 705 may include duplicative PPDU preambles 710, and each PPDU 705 of the multiple PPDUs 705 may include a different PPDU data 715. For example, each PPDU 705 of the multiple PPDUs 705 may include a portion of the management frame. Techniques may be described herein with respect to the first AP 702-a transmitting frames where at least a portion of the frame is transmitted in duplicate format. However, it should be understood that the second AP 702-b (and other APs 702) also may transmit frames using the formats and techniques described herein. Additionally, some of the techniques are described with reference to coordinating or executing a CAP procedure. However, various techniques may be applicable outside of coordinating or executing a CAP procedure.

In some examples, control frames transmitted via a non-HT duplicate PPDU format may include an indication of a bandwidth occupied by the PPDU. For example, if the first AP 702-a transmits a control frame via subcarriers within the operating bandwidth of the first AP 702-a, the non-HT duplicate PPDU may include an indication of the operating bandwidth of the first AP 702-a. Nearby STAs 704 may determine the bandwidth of the subsequent control frame transmissions (such as control frame transmission in a TXOP) based on the indication of the bandwidth occupied by the PPDU.

The STAs 704 in the neighborhood that are not part of a CAP operation (such as TXOP) may determine whether to invoke other features (such as such nonprimary channel access) based on the indication of the bandwidth occupied by the PPDU. The bandwidth may be carried in a service field of the PPDU, another field of the PPDU, or within the frame body. In some examples, the second AP 702-b may transmit a CTS frame in response to multiuser request to send transmissions (MU-RTS TXs) via a non-HT duplicate PPDU, and the CTS frame may carry the indication of the bandwidth occupied by the PPDU. In some examples, the second AP 702-b may transmit a response to a buffer status report poll (BSRP) trigger frame via a non-HT duplicate format PPDU. The response frame may be a multi-STA blockack (MBA) frame. One or more fields of the MBA frame may include an identifier field, such as a combination of an association identifier (AID) and traffic identifier (TID) field of the non-HT duplicate format PPDU, which carries the indication of the bandwidth occupied by the PPDU. Non-HT duplicate PPDU format frames that carry the indication of the bandwidth may be used as part of CAP procedure coordination or execution or separate from CAP procedure coordination or execution.

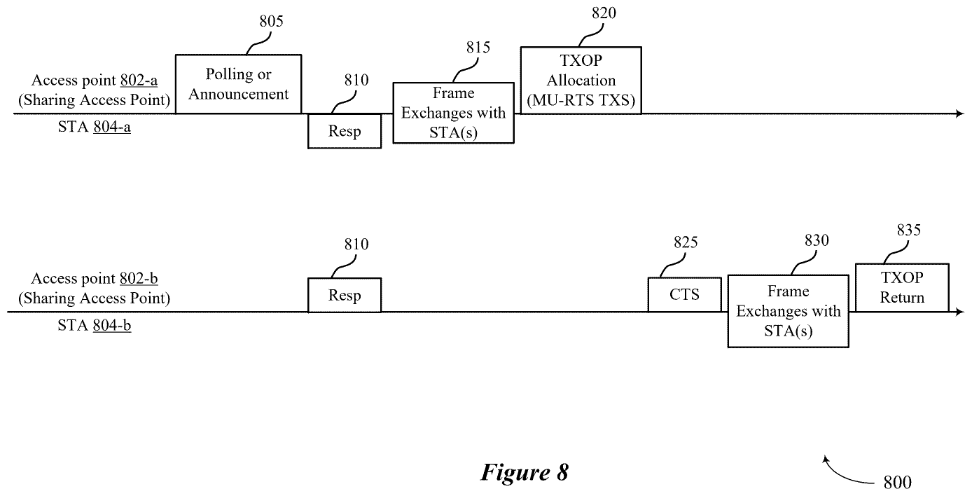

FIG. 8 shows an example of a communication sequence 800 that supports communications between APs with different channel configurations. The communication sequence 800 illustrates example operations between APs 802 and the STAs 804 in accordance with an example CAP procedure. The APs 802 may be examples of the APs described with respect to FIG. 1-7, and the STAs 804 may be examples of the STAs described with respect to FIG. 1-7. The CAP procedure illustrated in the communication sequence 800 is a C-TDMA procedure. However, it should be understood that the techniques described herein may be applicable to other types of CAP procedures. Other CAP procedures may include coordinated restricted target wake time (R-TWT), coordinated spatial reuse, or coordinated beamforming. Thus, the resources of a TXOP that are allocated in accordance with the coordination messaging described herein may include time domain resources, frequency domain resources, spatial resources, beamforming resources, or any combination thereof. In accordance with the C-TDMA procedure a first AP 802-a may be referred to as the sharing AP, and a second AP 802-b may be referred to as the shared AP. The first AP 802-a may serve one or more STAs 804, such as a first STA 804-a, and the second AP 802-b may serve one or more STAs 804, such as a second STA 804-b.

At 805, the first AP 802-a may transmit an initial control frame (ICF) (such as a polling or announcement frame). For example, during a CAP operation (such as a TXOP of a C-TDMA procedure), the first AP 802-a and the second AP 802-b may communicate via control frames (such as the at least a portion of the frames involved in a frame exchange during a CAP TXOP may be control frames). The ICF may function as a polling a or a scheduling announcement frame, and may solicit responses from one or more other APs 802, such as the second AP 802-b or one or more STAs 804, such as the first STA 804-a, participating in frame exchanges at 815. For example, the ICF may function as a polling frame and include information to poll other APs 802 on whether the other APs 802 are willing to participate in the CAP, such as the C-TDMA procedure. Additionally, or alternatively, the ICF may function as a scheduling announcement frame and include information that schedules resources for a TXOP, such as a TXOP at 820 (such as for a C-TDMA procedure). In some examples, the ICF announces the schedule for the CAP, such as the schedule for the C-TDMA procedure. For example, the ICF may include information that indicates the resources during which the TXOP allocation (such as at 820) is to be transmitted.

The first AP 802-a may transmit the ICF (such as schedule announcement or BSRP trigger frame) via a non-HT duplicate PPDU format. When one or more in-BSS STAs 804 are involved, the frame may occupy the operating bandwidth of the sharing (such as transmitting) AP 802, such as the first AP 802-a. That is, the non-HT duplicate PPDU format PPDU may be duplicated in each subchannel of the sharing AP 802-a. When polling the one or more participating APs 802 and not polling the STAs 804, the frame may occupy (such as the maximum of) the overlapping bandwidth between the sharing AP 802, such as the first AP 802-a, and the one or more polled APs 802, such as the second AP 802-b. That is, the non-HT duplicate PPDU format PPDU may be duplicated in the overlapping bandwidth between the AP 802-a and the AP 802-b. The resource unit (RU) allocation within such a frame may be with reference to the primary channel (such as P20) of the sharing first AP 802-a. For example, the one or more receiving APs, such as the second AP 802-b, may compute the RU location based on the primary channel of the sharing AP 802, such as the first AP 802-a. A coordinating AP 802, such as the first AP 802-a or the second AP 802-b, may determine the primary channel of the one or more peer AP 802 during a CAP discovery phase.

At 810, the one or more other APs 802, such as the second AP 802-b, or one or more STAs 804 participating in the frame exchange at 815, such as the first STA 804-a, may transmit a response to the ICF (such as polling or announcement frame). For example, in response to the ICF at 805, the one or more other APs 802, such as the second AP 802-b, may transmit information in a response frame (such as an initial control response (ICR) frame). The information may indicate whether the AP 802 is to participate in the CAP procedure. In some examples, the response (such as the ICR) to the ICF (such as schedule announcement frame) may be a multi-STA block acknowledgment (MBA) carrying resource request information. (when responder intends to participate). In some examples, the response may be a buffer status report (or a variant thereof designed for coordinated AP operation), a clear to send (CTS), a MBA carrying buffer status information, or a public action management frame carrying buffer status or resource request information.

At 815, the first AP 802-a may communicate with one or more STAs 804, such as the first STA 804-a, using a communication frame (such as a data frame). The communication frame may be based on information included in the ICF (such as the announcement frame) at 805.

At 820, the first AP 802-a may transmit information in a resource allocation frame (such as a TXOP allocation frame), which may indicate resource units (RUs) or subchannels via which the one or more APs 802, such as the second AP 802-b, are to communicate in accordance with the CAP procedure. The first AP 802-a may transmit the resource allocation frame (such as TXOP allocation or MU-RTS TXS frame) via a non-HT duplicate PPDU format. The frame may occupy a bandwidth equal to or lesser than the overlapping bandwidth between the sharing AP 802, such as the first AP 802-a, and the one or more shared APs 802, such as the second AP 802-b.

At 825, one or more APs 802, such as the second AP 802-b, may transmit a response message. For example, the second AP 802-b may transmit, in response to the resource allocation frame (such as TXOP allocation frame), a clear to send (CTS) frame. The one or more shared APs 802 may transmit, in response to resource allocation, the CTS response via a non-HT duplicate PPDU. The non-HT duplicate PPDU may occupy the lesser bandwidth of the bandwidth of the resource allocation frame or the bandwidth of the unoccupied portion within a soliciting bandwidth. The lesser bandwidth may be the bandwidth that the one or more shared APs 802 may use during the shared portion of the TXOP at 830. For example, the sharing AP 802 may allocate a 80 MHz bandwidth for a resource allocation frame, but the shared AP 802 may detect that another device (such as another AP) is transmitted in a 20 MHz portion of the 80 MHz allocated bandwidth. As such, the response frame (such as the CTS response frame) may occupy the remaining 60 MHz instead of the full 80 MHz that was allocated.

At 830, the second AP 802-b may communicate with one or more STAs, such as the second STA 804-b, via allocated resources, such as resources allocated via the resource allocation frame (such as TXOP allocation frame).

At 835, the second AP 802-b may transmit a return resource frame (such as a TXOP return message or termination frame), which may release a portion of the resources assigned via the resource allocation frame (such as resources of the TXOP). The return resource frame may be transmitted via a management frame or an MBA. The second AP 802-b may transmit the return resource frame (such as if signaled via the MBA) via a non-HT duplicate PPDU format occupying the bandwidth used during the shared portion of the TXOP. The return resource frame may include a scope within the TXOP. For example, the return resource frame may indicate a return of the TXOP to the first AP 802-a. The return resource frame may not terminate the long term coordination agreement between the APs 802. The return resource frame may indicate that the shared AP, such as the second AP 802-b, is done using the shared resource (such as the TXOP).

A network allocation vector (NAV) for one or more STAs 804 associated with a participating AP 802 may be based on a duration field of a control frame (such as the ICF at 805 or other control frame). When at least one of the address fields (such as receiver address (RA), transmitter address (TA), or BSS identifier) of the control frame corresponds with an AP 802 associated with an STA 804, the STA 804 may set an intra-BSS NAV based on the duration field of the control frame. For example, if the first STA 804-a receives a first control frame with at least one address field indicating the first AP 802-a, the first STA 804-a may set an intra-BSS NAV based on the duration field included in the first control frame.

If a trigger frame (such as the ICF at 805) is directed to a peer AP 802, an STA 804 associated with both APs 802 may set a respective intra-BSS NAV based on the duration field of the control frame. For example, in case of C-TDMA, the TXOP allocation (such as MU-RTS TXS) may include a RA indicating the shared second AP 802-b (RA=shared AP) and a TA indicating the sharing first AP 802-a (TA=sharing AP). The first AP 802-a and the second AP 802-b may set a respective intra-BSS NAV based on the duration field associated with the TXOP allocation. If the PPDU containing the control frame is a non-HT duplicate PPDU, an STA 804 may receive the frame on a primary channel (such as P20), and the STA 804 may set an intra-BSS NAV or an inter-BSS NAV based on the address fields associated with the control frame (such as when conditions described herein are met). The intra-BSS NAV may be based on the duration field for a single transaction, a portion of a TXOP, or an entire TXOP.

An AP 802, such as the first AP 802-a or the second AP 802-b, may transmit some broadcast management frames (such as beacon frames, fast initial link setup (FILS) discovery frames, and broadcast probe response frames) via a non-HT dup format PPDU. In such cases, the same content may be duplicated across each 20 MHz subchannel within an operating bandwidth of the AP 802, which may make the effective bandwidth of the non-HT duplicate format PPDU 20 MHz. Additionally, if a unicast management frame is transmitted via a non-HT duplicate PPDU format, an acknowledgment from a recipient may be lost. For example, the recipient of the unicast management frame transmitted via non-HT duplicate PPDU format may transmit an acknowledgment to a management frame via the primary channel of the recipient, and a transmitting device may not receive the acknowledgment based on the primary channel of the transmitting device being different than the primary channel of the recipient.

In some examples, the first AP 802-a may transmit a unicast management frame via a non-HT duplicate PPDU format to the second AP 802-b. In such cases, the second AP 802-b may transmit feedback corresponding to (e.g., acknowledgment of) the unicast management frame via a non-HT duplicate PPDU format.

To improve communication efficiency (such as increase the effective bandwidth of broadcast management frames), an AP 802, such as the first AP 802-a, may transmit unicast management frames to another AP 802, such as the second AP 802-b. The unicast management frames (such as or other management frames) between the coordinating APs 802 may not be transmitted via the non-HT duplicate format PPDU, which may be inefficient in some cases. Instead, the APs 802-a may exchange management frames via a SU transmissions (such as an extremely high throughput (EHT) SU transmission). Example SU transmissions may include CAP unicast frames, such as frames exchanged during negotiation, notification frames (such as notification frames indicating updates), or CAP teardown frames. Additionally, a portion of the SU transmission, such as the preamble, may be duplicated across subchannels within at least a portion the operating bandwidth of the second AP 802-b (such as all the 20 MHz subchannels within the overlapping bandwidth between the first AP 802-a and the second AP 802-b). Additionally, the content of the PPDU (such as the header of the PPDU) may be transmitted utilizing the entire bandwidth. A coordinating AP 802, such as the second AP 802-b, may receive the SU transmission based on another AP 802, such as the first AP 802-a, transmitting the PPDU preamble of the management frame via the overlapping bandwidth. The second AP 802-b (such as a receiver) may transmit an acknowledgment via the same bandwidth as the soliciting PPDU. Additionally, or alternatively, the soliciting PPDU may indicate an RU or subchannel for the second AP 802-b to transmit the acknowledgment. In some systems the second AP 802-b may transmit the acknowledgment in a non-HT duplicate PPDU. The non-HT duplicate PPDU may be duplicated across an operating bandwidth of the second AP 802-b or the overlapping bandwidth, such as the overlapping bandwidth with respect to the first AP 802-a and the second AP 802-b. The SU transmission may provide the detectability benefits of the non-HT duplicate PPDU while delivering content using a relatively higher bandwidth. As described in further detail herein, the preamble that is duplicated may be used by the receiver device, such as the AP 802-b, to determine whether to process the remainder of the frame (such as the content or the MAC header).

For management frame communication, a transmitting AP 802, such as the first AP 802-a, may transmit the management frame as an SU transmission that spans the overlapping bandwidth. The overlapping bandwidth may be the bandwidth overlapping between the operating bandwidth of the first AP 802-a and the operating bandwidth of the second AP 802-b, as described with reference to FIG. 9.

The first AP 802-a may transmit the preamble of the PPDU as part of the SU transmission via one or more subchannels included in the overlapping bandwidth. The preamble may include one or more parameter or field values. In some examples, an uplink or downlink field or bit (such as bit 6 of universal signal field (U-SIG)-1) may be set to one to indicate the PPDU is addressed to another AP 802. In some examples, one or more BSS color field (such as bits 7-12 of U-SIG-1) may be set to either 0 or a BSS color field corresponding to the receiving AP 802, such as the second AP 802-b. In some examples, the one or more BSS color field may be reserved for CAP procedures (such as a plurality of CAP procedure types) or for specific CAP procedure type. For example, the BSS color field may be set to indicate a C-TDMA procedure. In some examples, one or more PPDU type and compression mode bits (such as bits 0 and 1 of U-SIG-2) may be set to one. In some examples, one or more identifier fields, such as STA-ID bits (such as bits 0-10 of a user information field), may be set to either the AP identifier assigned by the receiving AP, such as the second AP 802-b, to the transmitting AP, such as the first AP 802-a, or a special AID for CAP operation.

The first AP 802-a may transmit, as part of the management frame, a header, such as a MAC header, via non-duplicate format that spans the bandwidth of the transmitting AP. The MAC header may include one or more parameter values. In some examples, the header may include an indication of a frame type or subtype (such as a CAP action frame). Additionally, one or more fields of the header may indicate a MAC address of either the transmitting AP or the receiving AP. For example, A TA field (such as A2 field) may be set to a MAC address of the transmitting AP, such as the first AP 802-a, and a BSS ID field (such as A3 field) may be set to a MAC address of the receiving AP, such as the second AP 802-b.

As described herein, the preamble of the SU transmission (such as a management frame transmission) may be duplicated across one or more subchannels (such as 20 MHz subchannels) of the overlapping bandwidth between the coordinating APs 802 (such as the transmission bandwidth). The duplicated preambles may enable devices in the neighborhood (such as participating APs 802) that fall within transmission bandwidth to receive and decode the preamble. For example, a receiving AP 802, such as the second AP 802-b, may receive a management frame as part of an SU transmission that spans the overlapping bandwidth.

The second AP 802-b may determine to ignore (such as not process the contents of) a PPDU based on a contents of the PPDU preamble. In some examples, the second AP 802-b may ignore the PPDU based on the BSS color not matching a BSS color corresponding to the second AP 802-b unless the value of the BSS color is zero. In some examples, the second AP 802-b may ignore the PPDU based on the BSS color not matching one or more BSS colors reserved for CAP or a specific CAP procedure (such as CAP procedure type). In some examples, the second AP 802-b may ignore the PPDU based on the uplink or downlink bit being zero. In some examples, the second AP 802-b may ignore the PPDU based on the one or more PPDU type and compression mode bits being zero. In some examples, the second AP 802-b may ignore the PPDU based on the STA-ID not matching a value the second AP 802-b has assigned to an associated STAs (such as the second STA 804-b) or to another AP 802, such as the first AP 802-a, with which the second AP 802-b has negotiated CAP operations. As such, the duplicated preamble may be detected on the primary channel of the receiving device and used to determine whether the receiving device is to continue processing the other portions of the PPDU (such as non-duplicate portions of the PPDU), such as the MAC header. Additionally, or alternatively, the second AP 802-b may ignore (such as not respond to or perform an action based on) the PPDU based on a contents of the MAC header. In some examples, the second AP 802-b may ignore the PPDU based on a frame type or subtype included in the MAC header not being a CAP. In some examples, the second AP 802-b may ignore the PPDU based on the A2 field not matching that of another AP 802, such as the first AP 802-a, with whom the second AP 802-b has negotiated CAP. In some examples, the second AP 802-b may ignore the PPDU based on the BSSID not matching a BSS ID corresponding to the second AP 802-b. If the second AP 802-b does not determine to ignore the PPDU, the second AP 802-b may process the frame.

Although initially described for management frames, data frames and extension frames may follow a similar duplication procedure as described for management frames. That is, data frames may include information or preambles that is duplicated across multiple subchannels of a bandwidth of a transmitting device and may contain data or other information that is transmitted in non-duplicate format (such as spanning the bandwidth of the transmitting device).

FIG. 9 shows an example of channel configurations 900 that support communications between APs with different channel configurations. The channel configurations 900 illustrate example configurations of an operating bandwidth and a primary channel (such as P20 905) that are used by a first AP 902-a and a second AP 902-b, which may be examples of the APs described herein with reference to FIG. 1-8. Each primary channel may be configured as a 20 MHz channel, which is why the primary channel may be referred to as P20 905. It should be understood the techniques described herein may be applicable to different bandwidth primary channels or different channel configurations from those illustrated in FIG. 8. The first AP 902-a may be an example of a sharing AP, and the second AP 902-b may be an example of a shared AP in accordance with a CAP procedure (such as C-TDMA). Additionally, or alternatively, the first AP 902-a may be an example of a shared AP, and the second AP 902-b may be an example of a sharing AP in accordance with a CAP procedure.

As illustrated in FIG. 9, the sharing and the shared APs 902 may have different primary channels and BSS operating bandwidths. In the case of the same operating bandwidths, the bandwidths may be fully overlapping (such as in channel configuration 900-a) or partially overlapping (such as in channel configuration 900-c). In cases of different operating bandwidths, the operating bandwidths of one AP may be a subset of the bandwidth of another AP, as illustrated in channel configuration 900-b.

Techniques described herein support CAP procedures for APs 902 with different operating bandwidths as well as different primary channels (such as 20 MHz channels). For example, different options are described herein to support C-TDMA operation (and other CAP operations) between participating APs 902 having different configurations (such as operating bandwidths or 20 MHz channels).

The coordinating APs 902 may perform CAP (such as C-TDMA) based on the P20s 905 (such as primary channels) of the coordinating APs 902 lying within the overlapping operation of the operating bandwidths of the coordinating APs 902. For example, in channel configuration 900-a, channel configuration 900-b, and channel configuration 900-c, the P20 905-a of the first AP 902-a lies within the operating bandwidth of the second AP 902-b, and the P20 905-b of the second AP 902-b lies within the operating bandwidth of the first AP 902-a.

During a shared portion of a TXOP, a transmissions from a shared AP, such as the first AP 902-a may not go beyond the overlapping bandwidth portion of the operating bandwidth of the first AP 902-a. For example, the first AP 902-a may transmit exchange frame communication with the second AP 902-b via the overlapping bandwidth. The shared AP 902, such as the first AP 902-a, may not transmit in the non-overlapping portion of the operating bandwidth of the shared AP 902. For example, in channel configuration 900-c, the first AP 902-a may not transmit frame communication to the second AP 902-b via bandwidth portion 910.

In channel configuration 900-a, the operating bandwidth of the first AP 902-a and the second AP 902-b may be 160 MHz. A primary 160 MHz (including the P20 905-a) of the first AP 902-a and a primary 160 MHz (including the P20 905-b) of the second AP 902-b may completely overlap with each other. The coordinating APs 902 may exchange frame (such as management frames) via EHT 160 MHz SU transmissions based on the overlapping bandwidth as described herein.

In channel configuration 900-b, the operating bandwidth of the first AP 902-a may be 160 MHz, and the operating bandwidth of the second AP 902-b may be 80 MHz. A primary 80 MHz (including the P20 905-a) of the first AP 902-a and a primary 80 MHz (including the P20 905-b) of the second AP 902-b may completely overlap with each other. The coordinating APs 902 may exchange frames via EHT 80 MHz SU transmissions based on the overlapping bandwidth (such as part of CAP operations).

In channel configuration 900-c, the operating bandwidth of the first AP 902-a may be 320 MHz, and the operating bandwidth of the second AP 902-b may be 320 MHz. A primary 160 MHz (including the P20 905-a) of the first AP 902-a and a primary 160 MHz (including the P20 905-b) of the second AP 902-b may completely overlap with each other. The coordinating APs 902 may exchange frames via EHT 160 MHz SU transmissions based on the overlapping bandwidth (such as part of CAP operations).

In channel configuration 900-d, the operating bandwidth of the first AP 902-a may be 160 MHz, and the operating bandwidth of the second AP 902-b may be 80 MHz. The P20 905-a of the first AP 902-a may not overlap with the operating bandwidth of the second AP 902-b. In channel configuration 900-e, the operating bandwidth of the first AP 90-a may be 320 MHz, and the operating bandwidth of the second AP 902-b may be 320 MHz. The P20-b of the second AP 902-b may not overlap with the operating bandwidth of the first AP 902-a. When there is no primary bandwidth which completely overlaps between the two BSSs (such as operating bandwidth), the two APs 902 may not perform a CAP procedure (such as C-TDMA operation).

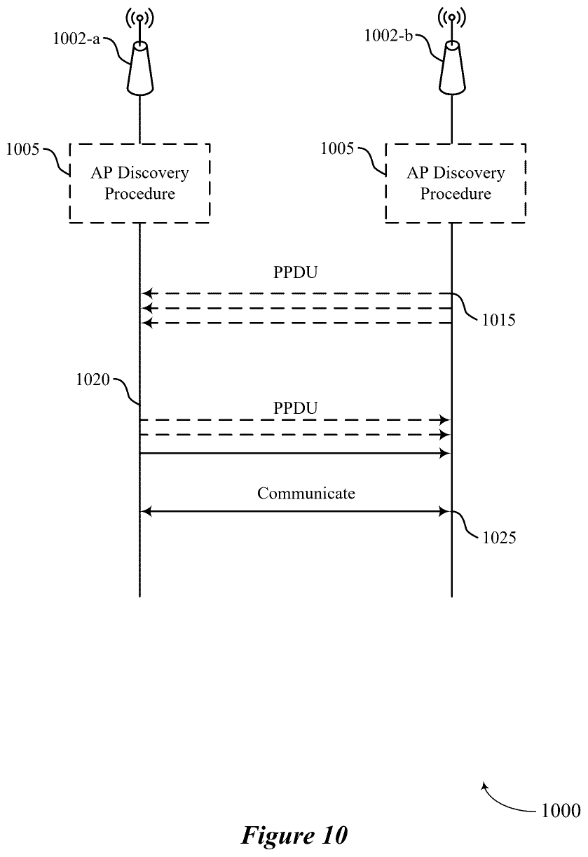

FIG. 10 shows an example of a process flow 1000 that supports communications between APs with different channel configurations. The process flow 1000 includes a first AP 1002-a and a second AP 1002-b, which may be examples of the corresponding devices described herein with respect to FIG. 1-9. Alternative examples of the following may be implemented, where some operations are performed in a different order than described or are not performed at all. In some examples, operations may include additional features not mentioned below, or further operations may be added. Although the first AP 1002-a and the second AP 1002-b are shown performing the operations of the process flow 1000, some aspects of some operations also may be performed by one or more other components or systems. The first AP 1002-a and the second AP 1002-b may communicate with one or more STAs. Although two APs 1002 are illustrated in FIG. 10, it should be understood that the process flow 1000 may include any quantity of APs 1002.

At 1005, the first AP 1002-a, the second AP 1002-b, or both, may perform one or more AP discovery procedures. For example, the first AP 1002-a may implement one or more discovery procedures without using a broadcast management frame in non-HT duplicate PPDU format. In accordance with a first option for AP discovery, the first AP 1002-a may perform an off-channel scan via multiple subchannels of a first bandwidth associated with the first AP 1002-a, where the multiple subchannels are separate from a first subchannel of the bandwidth that includes a first primary channel of the first AP 1002-a. Additionally, a scanned subchannel of the multiple subchannels may be associated with a second primary channel of the second AP 1002-b. In some examples, before performing the off-channel scan, the first AP 1002-a may transmit an indication of unavailability on the first primary channel of the first AP 1002-a within the first bandwidth. The transmission of the indication of unavailability may be associated with a bTWT procedure, a 11bn DPS procedure, or another similar procedure.

In accordance with a second option for AP discovery at 1005, the first AP 1002-a may utilize one or more associated non-AP STAs to scan for other APs. In such cases, the first AP 1002-a may transmit, to one or more STAs associated with the first AP 1002-a, a request to scan multiple subchannels within a first bandwidth associated with the first AP 1002-a. The multiple subchannels may not include a first primary channel associated with the first AP 1002-a. The request to scan the multiple subchannels may include an indication of one or more filters associated with one or fields that may be included in a beacon signal transmitted by neighboring AP (such as the second AP 1002-b). Additionally, or alternatively, the request to scan may be in the form of a beacon report request (such as 802.11K) or event report. In response to the request to scan, the first AP 1002-a may receive, from at least one STA, an indication of an identified AP, such as the second AP 1002-b. The indication may include an AP identifier associated with the identified AP, a primary channel associated with the identified AP, a second bandwidth associated with the identified AP, or other information associated with the identified AP.

In accordance with a third option for AP discovery at 1005, the first AP 1002-a may utilize an auxiliary radio of the first AP 1002-a to discover other APs, such as the second AP 1002-b. In such cases, the first AP 1002-a may transmit a request to the auxiliary radio to perform a scan for other APs. The auxiliary radio may execute a scan (such as in response to the request) of multiple subchannels and identify another AP, such as the second AP 1002-b. The first AP 1002-a may receive information associated with the identified AP based on the auxiliary radio scan. Such information may include an AP identifier associated with the identified AP, a primary channel associated with the identified AP, a second bandwidth associated with the identified AP, or other information associated with the identified AP. During the auxiliary radio scan, the first AP may monitor or otherwise utilize the first primary channel associated with the first AP 1002-a (such as via the primary radio of the first AP 1002-a). It should be understood that the second AP 1002-b also may implement one or more of the options described herein for AP discovery. Additionally, or alternatively, the first AP 1002-a, the second AP 1002-b, or both may implement backhaul communications for AP discovery.

At 1015, the first AP 1002-a may receive a PPDU. In some examples, the first AP 1002-a may receive, from a second AP 1002-b of one or more second APs 1002, a resource allocation frame including first information associated with the coordination of the resources. In some examples, the first AP 1002-a may receive, from the second AP 1002-b of the one or more second APs 1002, a first PPDU within the portion of the first bandwidth that overlaps with a second bandwidth of the second AP 1002-b. In some examples, the first AP 1002-a may receive, from the second AP 1002-b of the one or more second APs 1002, a first PPDU that includes an allocation of a resource for transmission of feedback associated with the first PPDU.

At 1020, the first AP 1002-a may transmit, to one or more second APs 1002 (such as the second AP 1002-b), a PPDU including information associated with coordination of resources for a CAP procedure. At least a portion of the PPDU may be duplicated and transmitted via respective subchannels of at least a portion of a first bandwidth associated with the first AP 1002-a based on the PPDU including the information associated with the coordination of resources for the CAP procedure. At least the portion of the PPDU may be duplicated and transmitted via the respective subchannels based on a first primary bandwidth of the first AP 1002-a being different than a second primary bandwidth of the one or more second APs 1002 (such as the second AP 1002-b).

In some examples, the PPDU may include a control frame. The first AP 1002-a may transmit duplicate versions of an entirety of the PPDU via the respective subchannels of at least the portion of the first bandwidth associated with the first AP based on the PPDU being a control frame associated with the coordination of the resources for the CAP procedure. The PPDU may include a non-HT duplicate PPDU frame format based on the PPDU being the control frame.

In some examples, the control frame may include an ICF (such as a schedule announcement frame) associated with the coordination of the resources. The first AP 1002-a may transmit the PPDU via the respective subchannels of an entirety of the first bandwidth associated with the first AP based on the PPDU being the ICF and being addressed to one or more STA serviced by the first AP 1002-a.

In some examples, the first AP 1002-a may transmit the PPDU via the respective subchannels of the portion of the first bandwidth that overlaps with a second bandwidth of a second AP of the one or more second APs based on the PPDU being addressed to the second AP 1002-b. In some examples, the first AP 1002-a may transmit the PPDU that includes one or more RU allocations for one or more receiving devices. The one or more RU allocations may be configured with reference to a primary channel (such as P20) of the first AP 1002-a.

In some examples, the control frame may include a resource allocation frame (such as a TXOP allocation frame) associated with the coordination of the resources.

The first AP 1002-a may transmit the PPDU via the respective subchannels of the portion of the first bandwidth that overlaps with a second bandwidth of a second AP 1002-b of the one or more second APs or via the respective subchannels of the portion that is less than an overlapping portion between the first bandwidth and the second bandwidth based on the control frame comprising the resource allocation frame.

In some examples, the first AP 1002-a may transmit, based on receiving the resource allocation frame at 1015, the PPDU as a response to the resource allocation frame and via the respective subchannels of the portion occupying a second bandwidth allocated via the resource allocation frame or the portion of the second bandwidth allocated via the resource allocation frame that is available for use by the first AP. The response may include the information that is second information associated with the coordination of the resources.

In some examples, the control frame may include a resource return frame (such as a TXOP return frame). The first AP 1002-a may transmit the PPDU via the respective subchannels of the portion of bandwidth used during a TXOP and returned via the resource return frame. In some examples, the first AP 1002-a may transmit the PPDU that includes a duration field and one or more address fields. The address fields may be indicative of whether one or more receiving devices are to configure an intra-BSS NAV associated with a value of the duration field for the CAP procedure. In some examples, the first AP 1002-a may transmit the PPDU that includes an indication of the first bandwidth associated with the first AP 1002-a. The indication may be carried via one or more fields of the PPDU.

In some examples, the PPDU may include a management frame. The first AP 1002-a may transmit duplicate versions of the portion (such as the preamble) of the PPDU via the respective subchannels of at least the portion of the first bandwidth associated with the first AP based on the PPDU being a management frame associated with the coordination of the resources for the CAP procedure. For example, the first AP 1002-a may transmit a header of the PPDU via an entirety of the first bandwidth associated with the first AP 1002-a based on the PPDU being the management frame associated with the coordination of the resources for the CAP procedure. The first AP 1002-a may transmit the PPDU as a SU frame format based on the PPDU being the management frame.

In some examples, the duplicate versions of the portion may include duplicate versions of a preamble of the PPDU. In some examples, the duplicate versions of the preamble may include an uplink/downlink bit that may be set to a value of one to indicate that the PPDU is addressed to the one or more second APs 1002 (such as the second AP 1002-b).

In some examples, the duplicate versions of the preamble may include a BSS color field. The BSS color field included in the duplicate versions of the preamble may include a value of zero that indicates that the PPDU is transmitted by the first AP 1002-a that is unassociated with a receiving device (such as the second AP 1002-b). In some examples, the BSS color field included in the duplicate versions of the preamble may include a value that indicates a CAP procedure type of the CAP procedure. In some examples, the BSS color field included in the duplicate versions of the preamble may include a value indicative of a set of CAP procedure types.

In some examples, the duplicate versions of the preamble may include an indication of a type of the PPDU, an indication compression mode for the PPDU, or both. In some examples, the duplicate versions of the preamble may include an indication of a STA identifier with a value of a first identifier of the first AP 1002-a assigned by the second AP 1002-b of the one or more second APs 1002, or a first value indicative of a CAP procedure type of the CAP procedure, or a second value indicative of a set of CAP procedure types. In some examples, the header of the PPDU transmitted via the entirety of the first bandwidth may include a frame type identifier or frame subtype identifier indicative of a CAP access frame, a first field indicative of a first address of the first AP, a second field indicative of a second address of a second AP of the one or more second APs, or a combination thereof. In some examples, the management frame may include a unicast frame associated with negotiation of the CAP procedure, associated with cancellation of the CAP procedure, or both.

In some examples, the first AP 1002-a may transmit the PPDU as a second PPDU including feedback associated with the first PPDU (such as the first PPDU received at 1015) via the portion of the first bandwidth. In some examples, the first AP 1002-a may transmit the PPDU as a second PPDU including feedback associated with the first PPDU via the allocated resource (such as the resources allocated by the first PPDU received at 1015). In some examples, the allocated resources may be associated with a primary channel of the second AP 1002-b. In some examples, the duplicate versions of the portion may include duplicate versions of the feedback associated with the first PPDU. That is, the feedback may be transmitted via a non-HT duplicate PPDU that is duplicated across subchannels of the operating bandwidth of the second AP 1002-b or the overlapping bandwidth (such as overlapping bandwidth respect to the first AP 1002-a and the second AP 1002-b).

In some examples, at 1020, the first AP 1002-a may transmit a control frame via duplicated PPDUs (e.g., non-HT duplicate PPDU format), where the duplicated PPDUs may be transmitted via respective subchannels of a first bandwidth associated with the first AP 1002-a. The control frame may include an indication of the first bandwidth associated with the first AP 1002-a (e.g., the operating bandwidth of the first AP 1002-a). The indication of the first bandwidth may be included in a service field of the PPDU, another field of the PPDU, or within a frame body of the PPDU. The control frame that is transmitted via the duplicated PPDUs and includes the indication of the first bandwidth may not be tied to, a part of, or associated with, a CAP procedure. That is, the control frame may be used for operations different from a CAP procedure. Additionally, a subchannel of the respective subchannels may be associated with a primary channel of the second AP 1002-b. In some examples, the first AP 1002-a may transmit a second control frame via duplicated PPDUs, where the duplicated PPDUs may be transmitted via the respective subchannels of the first bandwidth.

Additionally, the control frame that includes an indication of the first bandwidth associated with the first AP 1002-a may include a second field that indicates that another field (e.g., service field) carries the indication of the first bandwidth. For example, the TA field of the control frame may include an indication that another field (e.g., service field) within the frame carries the first bandwidth of the non-HT duplicate PPDU (the control frame).

At 1025, the first AP 1002-a may communicate with the one or more second APs (such as the second AP 1002-b) based on the information associated with the coordination and included in the PPDU.

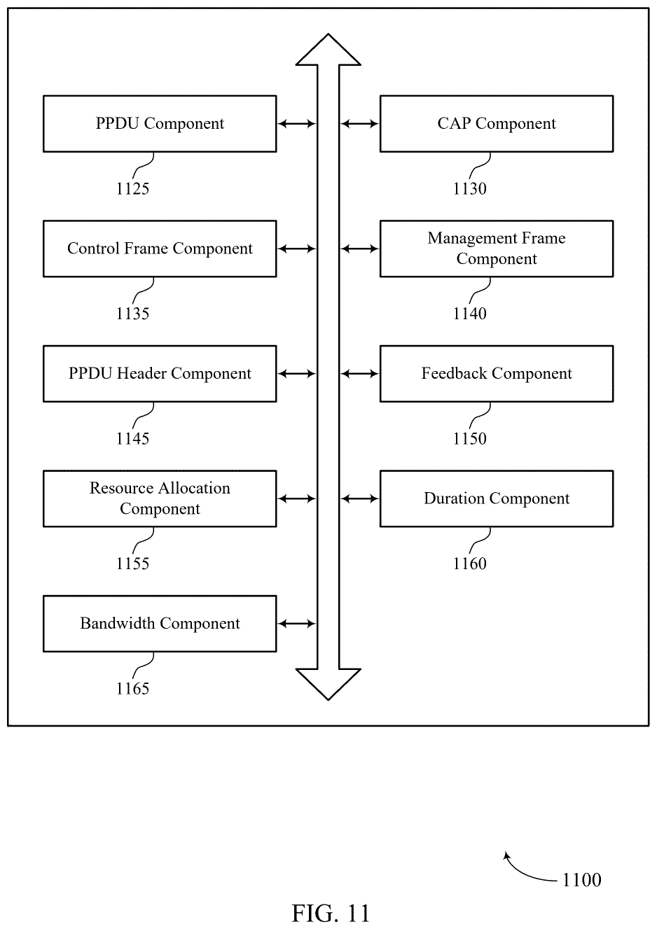

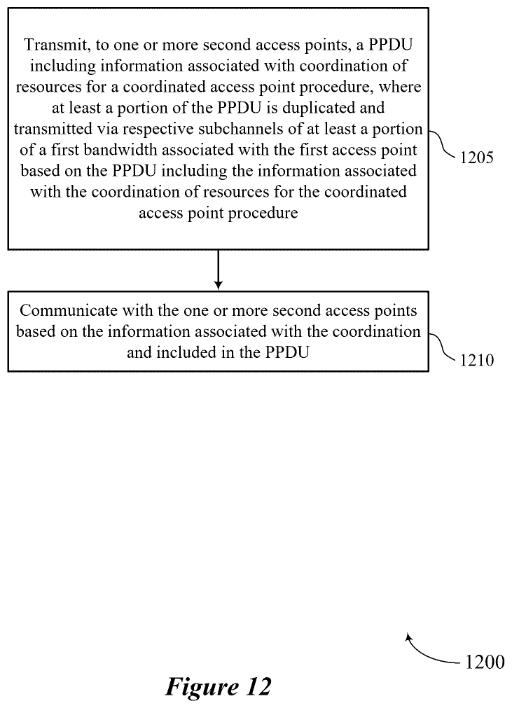

FIG. 11 shows a block diagram of an example wireless communication device 1100 that supports communications between APs with different channel configurations. In some examples, the wireless communication device 1100 is configured to perform the processes 1200, 1300, and 1400 described with reference to FIGS. 12, 13, and 14, respectively. The wireless communication device 1100 may include one or more chips, SoCs, chipsets, packages, components or devices that individually or collectively constitute or include a processing system. The processing system may interface with other components of the wireless communication device 1100, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1100 may transmit the information output from the chip. In such an example, the second interface may refer to an interface between the processing system of the chip and a reception component, such that the wireless communication device 1100 may receive information that is then passed to the processing system. In some such examples, the first interface also may obtain information, such as from the transmission component, and the second interface also may output information, such as to the reception component.

The processing system of the wireless communication device 1100 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1100 can be configurable or configured for use in an AP, such as the AP 102 described with reference to FIG. 1. In some other examples, the wireless communication device 1100 can be an AP that includes such a processing system and other components including multiple antennas. The wireless communication device 1100 is capable of transmitting and receiving wireless communications in the form of, for example, wireless packets. For example, the wireless communication device 1100 can be configurable or configured to transmit and receive packets in the form of physical layer PPDUs and MPDUs conforming to one or more of the IEEE 802.11 family of wireless communication protocol standards. In some other examples, the wireless communication device 1100 can be configurable or configured to transmit and receive signals and communications conforming to one or more 3GPP specifications including those for 5G NR or 6G. In some examples, the wireless communication device 1100 also includes or can be coupled with one or more application processors which may be further coupled with one or more other memories. In some examples, the wireless communication device 1100 further includes at least one external network interface coupled with the processing system that enables communication with a core network or backhaul network that enables the wireless communication device 1100 to gain access to external networks including the Internet.

The wireless communication device 1100 includes a PPDU component 1125, a CAP component 1130, a control frame component 1135, a management frame component 1140, a PPDU header component 1145, a feedback component 1150, a resource allocation component 1155, a duration component 1160, and a bandwidth component 1165. Portions of one or more of the PPDU component 1125, the CAP component 1130, the control frame component 1135, the management frame component 1140, the PPDU header component 1145, the feedback component 1150, the resource allocation component 1155, the duration component 1160, and the bandwidth component 1165 may be implemented at least in part in hardware or firmware. For example, one or more of the PPDU component 1125, the CAP component 1130, the control frame component 1135, the management frame component 1140, the PPDU header component 1145, the feedback component 1150, the resource allocation component 1155, the duration component 1160, and the bandwidth component 1165 may be implemented at least in part by at least a processor or a modem. In some examples, portions of one or more of the PPDU component 1125, the CAP component 1130, the control frame component 1135, the management frame component 1140, the PPDU header component 1145, the feedback component 1150, the resource allocation component 1155, the duration component 1160, and the bandwidth component 1165 may be implemented at least in part by a processor and software in the form of processor-executable code stored in memory.

The wireless communication device 1100 may support wireless communication in accordance with examples as disclosed herein. The PPDU component 1125 is configurable or configured to transmit, to one or more second APs, a PPDU including information associated with coordination of resources for a CAP procedure, where at least a portion of the PPDU is duplicated and transmitted via respective subchannels of at least a portion of a first bandwidth associated with the first AP based on the PPDU including the information associated with the coordination of resources for the CAP procedure. The CAP component 1130 is configurable or configured to communicate with the one or more second APs based on the information associated with the coordination and included in the PPDU.

In some examples, to support transmitting the PPDU, the control frame component 1135 is configurable or configured to transmit duplicate versions of an entirety of the PPDU via the respective subchannels of at least the portion of the first bandwidth associated with the first AP based on the PPDU being a control frame associated with the coordination of the resources for the CAP procedure.

In some examples, to support transmitting the PPDU, the control frame component 1135 is configurable or configured to transmit the PPDU via the respective subchannels of an entirety of the first bandwidth associated with the first AP based on the PPDU being the initial control frame and being addressed to one or more stations serviced by the first AP.

In some examples, to support transmitting the PPDU, the control frame component 1135 is configurable or configured to transmit the PPDU via the respective subchannels of the portion of the first bandwidth that overlaps with a second bandwidth of a second AP of the one or more second APs based on the PPDU being addressed to the second AP.

In some examples, to support transmitting the PPDU, the resource allocation component 1155 is configurable or configured to transmit the PPDU that includes one or more resource unit allocations for one or more receiving devices, where the one or more resource unit allocations are configured with reference to a primary channel of the first AP.

In some examples, to support transmitting the PPDU, the control frame component 1135 is configurable or configured to transmit the PPDU via the respective subchannels of the portion of the first bandwidth that overlaps with a second bandwidth of a second AP of the one or more second APs or via the respective subchannels of the portion that is less than an overlapping portion between the first bandwidth and the second bandwidth based on the control frame including the resource allocation frame.

In some examples, the resource allocation component 1155 is configurable or configured to receive, from a second AP of the one or more second APs, a resource allocation frame including first information associated with the coordination of the resources. In some examples, the resource allocation component 1155 is configurable or configured to transmit, based on receiving the resource allocation frame, the PPDU as a response to the resource allocation frame and via the respective subchannels of the portion occupying a second bandwidth allocated via the resource allocation frame or the portion of the second bandwidth allocated via the resource allocation frame that is available for use by the first AP, the response including the information that is second information associated with the coordination of the resources.

In some examples, to support transmitting the PPDU, the resource allocation component 1155 is configurable or configured to transmit the PPDU via the respective subchannels of the portion of bandwidth used during a TXOP and returned via the resource return frame.

In some examples, to support transmitting the PPDU, the duration component 1160 is configurable or configured to transmit the PPDU that includes a duration field and one or more address fields that are indicative of whether one or more receiving devices are to configure an intra-BSS network allocation vector (NAV) associated with a value of the duration field for the CAP procedure.

In some examples, to support transmitting the PPDU, the bandwidth component 1165 is configurable or configured to transmit the PPDU that includes an indication of the first bandwidth associated with the first AP.

In some examples, the indication is carried via one or more fields of the PPDU.

In some examples, the PPDU includes a non-HT duplicate (non-HT duplicate) PPDU frame format based on the PPDU being the control frame.

In some examples, to support transmitting the PPDU, the management frame component 1140 is configurable or configured to transmit duplicate versions of the portion of the PPDU via the respective subchannels of at least the portion of the first bandwidth associated with the first AP based on the PPDU being a management frame associated with the coordination of the resources for the CAP procedure. In some examples, to support transmitting the PPDU, the PPDU header component 1145 is configurable or configured to transmit a header of the PPDU via an entirety of the first bandwidth associated with the first AP based on the PPDU being the management frame associated with the coordination of the resources for the CAP procedure.

In some examples, the duplicate versions of the portion include duplicate versions of a preamble of the PPDU.

In some examples, the duplicate versions of the preamble include an uplink/downlink bit that is set to a value of one to indicate that the PPDU is addressed to the one or more second APs.

In some examples, the duplicate versions of the preamble include a BSS color field.

In some examples, the BSS color field included in the duplicate versions of the preamble includes a value of zero that indicates that the PPDU is transmitted by the first AP that is unassociated with a receiving device.

In some examples, the BSS color field included in the duplicate versions of the preamble includes a value that indicates a CAP procedure type of the CAP procedure.

In some examples, the BSS color field included in the duplicate versions of the preamble includes a value indicative of a set of multiple CAP procedure types.

In some examples, the duplicate versions of the preamble include an indication of a type of the PPDU, an indication compression mode for the PPDU, or both.

In some examples, the duplicate versions of the preamble include an indication of a station identifier with a value of a first identifier of the first AP assigned by a second AP of the one or more second APs, or a first value indicative of a CAP procedure type of the CAP procedure, or a second value indicative of a set of multiple CAP procedure types.

In some examples, the header of the PPDU transmitted via the entirety of the first bandwidth includes a frame type identifier or frame subtype identifier indicative of a coordination access procedure access frame, a first field indicative of a first address of the first AP, a second field indicative of a second address of a second AP of the one or more second APs, or a combination thereof.

In some examples, the management frame includes a unicast frame associated with negotiation of the CAP procedure, associated with cancellation of the CAP procedure, or both.

In some examples, to support transmitting the PPDU, the PPDU component 1125 is configurable or configured to transmit the PPDU as a SU frame format based on the PPDU being the management frame.

In some examples, the PPDU component 1125 is configurable or configured to receive, from a second AP of the one or more second APs, a first PPDU within the portion of the first bandwidth that overlaps with a second bandwidth of the second AP. In some examples, the feedback component 1150 is configurable or configured to transmit the second PPDU including feedback associated with the first PPDU via the portion of the first bandwidth.

In some examples, the feedback component 1150 is configurable or configured to receive, from a second AP of the one or more second APs, a first PPDU that includes an allocation of a resource for transmission of feedback associated with the first PPDU. In some examples, the feedback component 1150 is configurable or configured to transmit the second PPDU including the feedback associated with the first PPDU via the allocated resource.

In some examples, the allocated resources are associated with a primary channel of the second AP.

In some examples, at least the portion of the PPDU is duplicated and transmitted via the respective subchannels based on a first primary bandwidth of the first AP being different than a second primary bandwidth of the one or more second APs.

FIG. 12 shows a flowchart illustrating an example process 1200 performable by or at a first AP that supports communications between APs with different channel configurations. The operations of the process 1200 may be implemented by a first AP or its components as described herein. For example, the process 1200 may be performed by a wireless communication device, such as the wireless communication device 1100 described with reference to FIG. 11, operating as or within a wireless AP. In some examples, the process 1200 may be performed by a wireless AP, such as one of the APs 102 described with reference to FIG. 1.

In some examples, in 1205, the first AP may transmit, to one or more second APs, a PPDU including information associated with coordination of resources for a CAP procedure, where at least a portion of the PPDU is duplicated and transmitted via respective subchannels of at least a portion of a first bandwidth associated with the first AP based on the PPDU including the information associated with the coordination of resources for the CAP procedure. The operations of 1205 may be performed in accordance with examples as disclosed herein. In some implementations, aspects of the operations of 1205 may be performed by a PPDU component 1125 as described with reference to FIG. 11.

In some examples, in 1210, the first AP may communicate with the one or more second APs based on the information associated with the coordination and included in the PPDU. The operations of 1210 may be performed in accordance with examples as disclosed herein. In some implementations, aspects of the operations of 1210 may be performed by a CAP component 1130 as described with reference to FIG. 11.

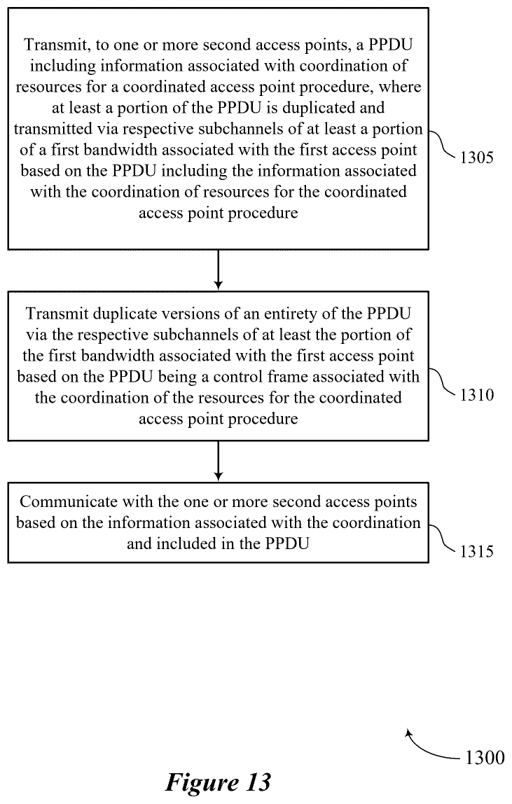

FIG. 13 shows a flowchart illustrating an example process 1300 performable by or at a first AP that supports communications between APs with different channel configurations. The operations of the process 1300 may be implemented by a first AP or its components as described herein. For example, the process 1300 may be performed by a wireless communication device, such as the wireless communication device 1100 described with reference to FIG. 11, operating as or within a wireless AP. In some examples, the process 1300 may be performed by a wireless AP, such as one of the APs 102 described with reference to FIG. 1.

In some examples, in 1305, the first AP may transmit, to one or more second APs, a PPDU including information associated with coordination of resources for a CAP procedure, where at least a portion of the PPDU is duplicated and transmitted via respective subchannels of at least a portion of a first bandwidth associated with the first AP based on the PPDU including the information associated with the coordination of resources for the CAP procedure. The operations of 1305 may be performed in accordance with examples as disclosed herein. In some implementations, aspects of the operations of 1305 may be performed by a PPDU component 1125 as described with reference to FIG. 11.

In some examples, in 1310, the first AP may transmit duplicate versions of an entirety of the PPDU via the respective subchannels of at least the portion of the first bandwidth associated with the first AP based on the PPDU being a control frame associated with the coordination of the resources for the CAP procedure. The operations of 1310 may be performed in accordance with examples as disclosed herein. In some implementations, aspects of the operations of 1310 may be performed by a control frame component 1135 as described with reference to FIG. 11.

In some examples, in 1315, the first AP may communicate with the one or more second APs based on the information associated with the coordination and included in the PPDU. The operations of 1315 may be performed in accordance with examples as disclosed herein. In some implementations, aspects of the operations of 1315 may be performed by a CAP component 1130 as described with reference to FIG. 11.

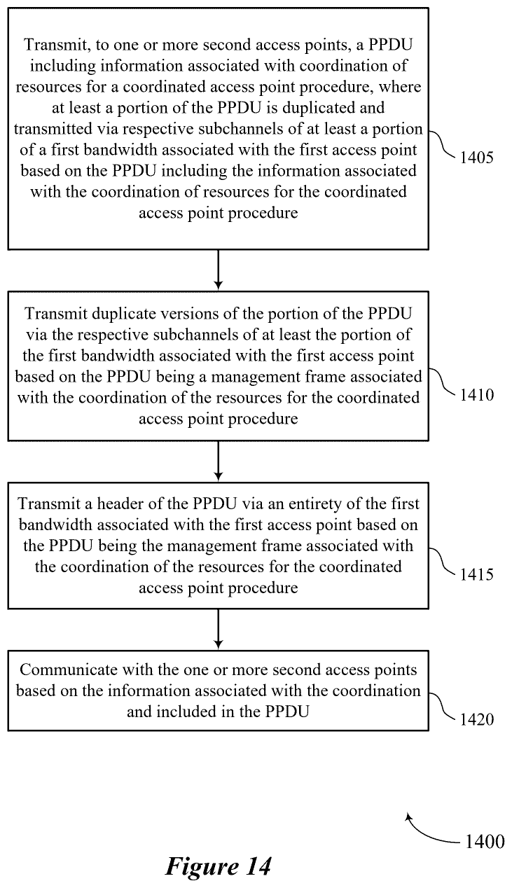

FIG. 14 shows a flowchart illustrating an example process 1400 performable by or at a first AP that supports communications between APs with different channel configurations. The operations of the process 1400 may be implemented by a first AP or its components as described herein. For example, the process 1400 may be performed by a wireless communication device, such as the wireless communication device 1100 described with reference to FIG. 11, operating as or within a wireless AP. In some examples, the process 1400 may be performed by a wireless AP, such as one of the APs 102 described with reference to FIG. 1.

In some examples, in 1405, the first AP may transmit, to one or more second APs, a PPDU including information associated with coordination of resources for a CAP procedure, where at least a portion of the PPDU is duplicated and transmitted via respective subchannels of at least a portion of a first bandwidth associated with the first AP based on the PPDU including the information associated with the coordination of resources for the CAP procedure. The operations of 1405 may be performed in accordance with examples as disclosed herein. In some implementations, aspects of the operations of 1405 may be performed by a PPDU component 1125 as described with reference to FIG. 11.

In some examples, in 1410, the first AP may transmit duplicate versions of the portion of the PPDU via the respective subchannels of at least the portion of the first bandwidth associated with the first AP based on the PPDU being a management frame associated with the coordination of the resources for the CAP procedure. The operations of 1410 may be performed in accordance with examples as disclosed herein. In some implementations, aspects of the operations of 1410 may be performed by a management frame component 1140 as described with reference to FIG. 11.

In some examples, in 1415, the first AP may transmit a header of the PPDU via an entirety of the first bandwidth associated with the first AP based on the PPDU being the management frame associated with the coordination of the resources for the CAP procedure. The operations of 1415 may be performed in accordance with examples as disclosed herein. In some implementations, aspects of the operations of 1415 may be performed by a PPDU header component 1145 as described with reference to FIG. 11.

In some examples, in 1420, the first AP may communicate with the one or more second APs based on the information associated with the coordination and included in the PPDU. The operations of 1420 may be performed in accordance with examples as disclosed herein. In some implementations, aspects of the operations of 1420 may be performed by a CAP component 1130 as described with reference to FIG. 11.

Implementation examples are described in the following numbered clauses:

Aspect 1: A method by a first AP, comprising: transmitting, to one or more second APs, a PPDU comprising information associated with coordination of resources for a CAP procedure, wherein at least a portion of the PPDU is duplicated and transmitted via respective subchannels of at least a portion of a first bandwidth associated with the first AP based at least in part on the PPDU comprising the information associated with the coordination of resources for the CAP procedure; and communicating with the one or more second APs based at least in part on the information associated with the coordination and included in the PPDU.

Aspect 2: The method of aspect 1, wherein transmitting the PPDU comprises: transmitting duplicate versions of an entirety of the PPDU via the respective subchannels of at least the portion of the first bandwidth associated with the first AP based at least in part on the PPDU being a control frame associated with the coordination of the resources for the CAP procedure.

Aspect 3: The method of aspect 2, wherein the control frame comprises an initial control frame associated with the coordination of the resources, and wherein transmitting the PPDU comprises: transmit the PPDU via the respective subchannels of an entirety of the first bandwidth associated with the first AP based at least in part on the PPDU being the initial control frame and being addressed to one or more stations serviced by the first AP.

Aspect 4: The method of any of aspects 2-3, wherein transmitting the PPDU comprises: transmitting the PPDU via the respective subchannels of the portion of the first bandwidth that overlaps with a second bandwidth of a second AP of the one or more second APs based at least in part on the PPDU being addressed to the second AP.

Aspect 5: The method of any of aspects 2-4, wherein transmitting the PPDU comprises: transmitting the PPDU that comprises one or more RU allocations for one or more receiving devices, wherein the one or more RU allocations are configured with reference to a primary channel of the first AP.

Aspect 6: The method of any of aspects 2-5, wherein the control frame comprises a resource allocation frame associated with the coordination of the resources, and wherein transmitting the PPDU comprises: transmit the PPDU via the respective subchannels of the portion of the first bandwidth that overlaps with a second bandwidth of a second AP of the one or more second APs or via the respective subchannels of the portion that is less than an overlapping portion between the first bandwidth and the second bandwidth based at least in part on the control frame comprising the resource allocation frame.

Aspect 7: The method of any of aspects 2-6, further comprising: receiving, from a second AP of the one or more second APs, a resource allocation frame including first information associated with the coordination of the resources, and wherein to transmit the PPDU, the processing system is further configured to cause the first AP to: transmitting, based at least in part on receiving the resource allocation frame, the PPDU as a response to the resource allocation frame and via the respective subchannels of the portion occupying a second bandwidth allocated via the resource allocation frame or the portion of the second bandwidth allocated via the resource allocation frame that is available for use by the first AP, the response comprising the information that is second information associated with the coordination of the resources.

Aspect 8: The method of any of aspects 2-7, wherein the control frame comprises a resource return frame, and wherein transmitting the PPDU comprises: transmit the PPDU via the respective subchannels of the portion of bandwidth used during a TXOP and returned via the resource return frame.

Aspect 9: The method of any of aspects 2-8, wherein transmitting the PPDU comprises: transmitting the PPDU that comprises a duration field and one or more address fields that are indicative of whether one or more receiving devices are to configure an intra-BSS NAV associated with a value of the duration field for the CAP procedure.

Aspect 10: The method of any of aspects 2-9, wherein transmitting the PPDU comprises: transmitting the PPDU that comprises an indication of the first bandwidth associated with the first AP.

Aspect 11: The method of aspect 10, wherein the indication is carried via one or more fields of the PPDU.

Aspect 12: The method of any of aspects 2-11, wherein the PPDU comprises a non-HT duplicate PPDU frame format based at least in part on the PPDU being the control frame.

Aspect 13: The method of aspect 1, wherein transmitting the PPDU comprises: transmitting duplicate versions of the portion of the PPDU via the respective subchannels of at least the portion of the first bandwidth associated with the first AP based at least in part on the PPDU being a management frame associated with the coordination of the resources for the CAP procedure; and transmitting a header of the PPDU via an entirety of the first bandwidth associated with the first AP based at least in part on the PPDU being the management frame associated with the coordination of the resources for the CAP procedure.

Aspect 14: The method of aspect 13, wherein the duplicate versions of the portion comprise duplicate versions of a preamble of the PPDU.

Aspect 15: The method of aspect 14, wherein the duplicate versions of the preamble comprise an uplink/downlink bit that is set to a value of one to indicate that the PPDU is addressed to the one or more second APs.

Aspect 16: The method of any of aspects 14-15, wherein the duplicate versions of the preamble comprise a BSS color field.

Aspect 17: The method of aspect 16, wherein the BSS color field included in the duplicate versions of the preamble comprises a value of zero that indicates that the PPDU is transmitted by the first AP that is unassociated with a receiving device.

Aspect 18: The method of aspect 16, wherein the BSS color field included in the duplicate versions of the preamble comprises a value that indicates a CAP procedure type of the CAP procedure.

Aspect 19: The method of aspect 16, wherein the BSS color field included in the duplicate versions of the preamble comprises a value indicative of a plurality of CAP procedure types.

Aspect 20: The method of any of aspects 14-19, wherein the duplicate versions of the preamble comprise an indication of a type of the PPDU, an indication compression mode for the PPDU, or both.

Aspect 21: The method of any of aspects 14-20, wherein the duplicate versions of the preamble comprise an indication of a station identifier with a value of a first identifier of the first AP assigned by a second AP of the one or more second APs, or a first value indicative of a CAP procedure type of the CAP procedure, or a second value indicative of a plurality of CAP procedure types.

Aspect 22: The method of any of aspects 13-21, wherein the header of the PPDU transmitted via the entirety of the first bandwidth comprises a frame type identifier or frame subtype identifier indicative of a coordination access procedure access frame, a first field indicative of a first address of the first AP, a second field indicative of a second address of a second AP of the one or more second APs, or a combination thereof.

Aspect 23: The method of any of aspects 13-22, wherein the management frame comprises a unicast frame associated with negotiation of the CAP procedure, associated with cancellation of the CAP procedure, or both.

Aspect 24: The method of any of aspects 13-23, wherein transmitting the PPDU comprises: transmitting the PPDU as a SU frame format based at least in part on the PPDU being the management frame.

Aspect 25: The method of any of aspects 1-24, further comprising: receiving, from a second AP of the one or more second APs, a first PPDU within the portion of the first bandwidth that overlaps with a second bandwidth of the second AP, wherein transmitting the PPDU as a second PPDU comprises: transmitting the second PPDU comprising feedback associated with the first PPDU via the portion of the first bandwidth.

Aspect 26: The method of any of aspects 1-25, further comprising: receiving, from a second AP of the one or more second APs, a first PPDU that includes an allocation of a resource for transmission of feedback associated with the first PPDU, wherein to transmit the PPDU as a second PPDU, the processing system is further configured to cause the first AP to: transmitting the second PPDU comprising the feedback associated with the first PPDU via the allocated resource.

Aspect 27: The method of aspect 26, wherein the allocated resources are associated with a primary channel of the second AP.

Aspect 28: A first AP comprising one or more memories storing processor-executable code, and one or more processors coupled with the one or more memories and individually or collectively operable to execute the code to cause the first AP to perform a method of any of aspects 1-27.

Aspect 29: A first AP comprising at least one means for performing a method of any of aspects 1-27.

Aspect 30: A non-transitory computer-readable medium storing code the code comprising instructions executable by one or more processors to perform a method of any of aspects 1-27.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset”refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first access point, comprising:
a processing system that includes processor circuitry and memory circuitry that stores code, the processing system configured to cause the first access point to:
transmit, to one or more second access points, a physical protocol data unit (PPDU) comprising information associated with coordination of resources for a coordinated access point procedure, wherein at least a portion of the PPDU is duplicated and transmitted via respective subchannels of at least a portion of a first bandwidth associated with the first access point based at least in part on the PPDU comprising the information associated with the coordination of resources for the coordinated access point procedure; and
communicate with the one or more second access points based at least in part on the information associated with the coordination and included in the PPDU.

2. The first access point of claim 1, wherein, to transmit the PPDU, the processing system is configured to cause the first access point to:
transmit duplicate versions of an entirety of the PPDU via the respective subchannels of at least the portion of the first bandwidth associated with the first access point based at least in part on the PPDU being a control frame associated with the coordination of the resources for the coordinated access point procedure.

3. The first access point of claim 2, wherein the control frame comprises an initial control frame associated with the coordination of the resources and wherein to transmit the PPDU, the processing system is configured to cause the first access point to:
transmit the PPDU via the respective subchannels of an entirety of the first bandwidth associated with the first access point based at least in part on the PPDU being the initial control frame and being addressed to one or more stations serviced by the first access point.

4. The first access point of claim 2, wherein, to transmit the PPDU, the processing system is configured to cause the first access point to:
transmit the PPDU via the respective subchannels of the portion of the first bandwidth that overlaps with a second bandwidth of a second access point of the one or more second access points based at least in part on the PPDU being addressed to the second access point.

5. The first access point of claim 2, wherein, to transmit the PPDU, the processing system is configured to cause the first access point to:
transmit the PPDU that comprises one or more resource unit allocations for one or more receiving devices, wherein the one or more resource unit allocations are configured with reference to a primary channel of the first access point.

6. The first access point of claim 2, wherein the control frame comprises a resource allocation frame associated with the coordination of the resources and wherein to transmit the PPDU, the processing system is configured to cause the first access point to:
transmit the PPDU via the respective subchannels of the portion of the first bandwidth that overlaps with a second bandwidth of a second access point of the one or more second access points or via the respective subchannels of the portion that is less than an overlapping portion between the first bandwidth and the second bandwidth based at least in part on the control frame comprising the resource allocation frame.

7. The first access point of claim 2, wherein the processing system is further configured to cause the first access point to:
receive, from a second access point of the one or more second access points, a resource allocation frame including first information associated with the coordination of the resources, and wherein to transmit the PPDU, the processing system is further configured to cause the first access point to:
transmit, based at least in part on receiving the resource allocation frame, the PPDU as a response to the resource allocation frame and via the respective subchannels of the portion occupying a second bandwidth allocated via the resource allocation frame or the portion of the second bandwidth allocated via the resource allocation frame that is available for use by the first access point, the response comprising the information that is second information associated with the coordination of the resources.

8. The first access point of claim 2, wherein the control frame comprises a resource return frame, and wherein to transmit the PPDU, the processing system is configured to cause the first access point to:
transmit the PPDU via the respective subchannels of the portion of bandwidth used during a transmission opportunity and returned via the resource return frame.

9. The first access point of claim 2, wherein, to transmit the PPDU, the processing system is configured to cause the first access point to:
transmit the PPDU that comprises a duration field and one or more address fields that are indicative of whether one or more receiving devices are to configure an intra-basic service set network allocation vector (NAV) associated with a value of the duration field for the coordinated access point procedure.

10. The first access point of claim 1, wherein, to transmit the PPDU, the processing system is configured to cause the first access point to:
transmit duplicate versions of the portion of the PPDU via the respective subchannels of at least the portion of the first bandwidth associated with the first access point based at least in part on the PPDU being a management frame associated with the coordination of the resources for the coordinated access point procedure; and
transmit a header of the PPDU via an entirety of the first bandwidth associated with the first access point based at least in part on the PPDU being the management frame associated with the coordination of the resources for the coordinated access point procedure.

11. The first access point of claim 10, wherein the duplicate versions of the portion comprise duplicate versions of a preamble of the PPDU.

12. The first access point of claim 11, wherein the duplicate versions of the preamble comprise an uplink/downlink bit that is set to a value of one to indicate that the PPDU is addressed to the one or more second access points.

13. The first access point of claim 11, wherein the duplicate versions of the preamble comprise a basic service set color field that comprises a comprises a value of zero that indicates that the PPDU is transmitted by the first access point that is unassociated with a receiving device, a value that indicates a coordinated access point procedure type of the coordinated access point procedure, or a value indicative of a plurality of coordinated access point procedure types.

14. The first access point of claim 11, wherein the duplicate versions of the preamble comprise an indication of a type of the PPDU, an indication compression mode for the PPDU, or both.

15. The first access point of claim 11, wherein the duplicate versions of the preamble comprise an indication of a station identifier with a value of a first identifier of the first access point assigned by a second access point of the one or more second access points, or a first value indicative of a coordinated access point procedure type of the coordinated access point procedure, or a second value indicative of a plurality of coordinated access point procedure types.

16. The first access point of claim 10, wherein the header of the PPDU transmitted via the entirety of the first bandwidth comprises a frame type identifier or frame subtype identifier indicative of a coordination access procedure access frame, a first field indicative of a first address of the first access point, a second field indicative of a second address of a second access point of the one or more second access points, or a combination thereof.

17. The first access point of claim 1, wherein the processing system is further configured to cause the first access point to:
receive, from a second access point of the one or more second access points, a first PPDU within the portion of the first bandwidth that overlaps with a second bandwidth of the second access point, wherein transmitting the PPDU as a second PPDU comprises:
transmit the second PPDU comprising feedback associated with the first PPDU via the portion of the first bandwidth.

18. The first access point of claim 1, wherein the processing system is further configured to cause the first access point to:
receive, from a second access point of the one or more second access points, a first PPDU that includes an allocation of a resource for transmission of feedback associated with the first PPDU, wherein to transmit the PPDU as a second PPDU, the processing system is further configured to cause the first access point to:
transmit the second PPDU comprising the feedback associated with the first PPDU via the allocated resource.

19. A method for wireless communication at a first access point, comprising:
transmitting, to one or more second access points, a physical protocol data unit (PPDU) comprising information associated with coordination of resources for a coordinated access point procedure, wherein at least a portion of the PPDU is duplicated and transmitted via respective subchannels of at least a portion of a first bandwidth associated with the first access point based at least in part on the PPDU comprising the information associated with the coordination of resources for the coordinated access point procedure; and
communicating with the one or more second access points based at least in part on the information associated with the coordination and included in the PPDU.

20. A non-transitory computer-readable medium storing code for wireless communication, the code comprising instructions executable by one or more processors to:
transmit, to one or more second access points, a physical protocol data unit (PPDU) comprising information associated with coordination of resources for a coordinated access point procedure, wherein at least a portion of the PPDU is duplicated and transmitted via respective subchannels of at least a portion of a first bandwidth associated with a first access point based at least in part on the PPDU comprising the information associated with the coordination of resources for the coordinated access point procedure; and
communicate with the one or more second access points based at least in part on the information associated with the coordination and included in the PPDU.
